(19) United States
(12) Patent Application Publication
(10) Pub. No.: US 2018/0322501 A1
(43) Pub. Date: Nov. 8, 2018

(54) SYSTEMS AND METHODS FOR REGISTERING FOR CARD AUTHENTICATION READS

(71) Applicant: Trusona, Inc., Scottsdale, AZ (US)

(72) Inventor: Ori Eisen, Scottsdale, AZ (US)

(21) Appl. No.: 15/996,755

(22) Filed: Jun. 4, 2018

Related U.S. Application Data
(63) Continuation of application No. PCT/US2016/068122, filed on Dec. 21, 2016.
(60) Provisional application No. 62/387,462, filed on Dec. 23, 2015.

(51) Int. Cl. G06Q 20/40; G06Q 20/34

(52) U.S. Cl. CPC G06Q 20/4016; G06Q 20/34

(57) ABSTRACT

A method of registering a user for performing a card authentication read is disclosed. An identity of the user may be verified in person. At least one official personal document of the user may be reviewed while face-to-face with the user. When the identity of the user is verified in person, a card reader having a card reader identifier may be provided to the user. Pre-registration data for one or more cards of the user may be received through the card reader. The pre-registration data for the one or more cards of the user may be stored to be associated with the card reader identifier in memory.

### CROSS-REFERENCE TO RELATED APPLICATIONS

This application is a continuation application of International Patent Application PCT/US2016/068122, filed Dec. 21, 2016, which claims the priority and benefit of U.S. Provisional Application No. 62/387,462, filed on Dec. 23, 2015, each of which is incorporated by reference herein in its entirety.

### BACKGROUND OF THE INVENTION

User identity verifications may not always be required for some user activities, such as user account login processes or various financial transactions. For example, user identity is not checked or verified when a user is trying to log into an online account or perform an online or in-store transaction. Such anonymity may result in identity theft and/or card theft which play large roles in fraudulent authentications. Both theft of a physical card and skimming of data on a card to create a clone permit fraudsters to assume a false identity for the purposes of an identity authentication and/or a financial transaction.

This becomes particularly concerning in situations involving identity authentications and/or large financial transactions. Particularly, users can conduct identity authentications online and fairly anonymously. Oftentimes, users can register themselves anonymously without identity validation, and use basic card information to conduct identity authentications and/or financial transactions. The anonymous user activities would not be detectable in traditional authentication processes.

### SUMMARY OF THE INVENTION

Systems and methods are provided for registering a user for performing card authentication reads during various activities (e.g., user account registrations, login processes, or various transactions). For instance, the user may receive and register a card reader after user identity is verified in person. A card reader identifier may be associated with the user account during the registration process. The card reader may be utilized during an authentication to collect various data. The user may also register one or more cards of the user using the card reader. For example during the registration, the card reader may be able to collect magnetic information on each card which may be unique to each card. During registration, the card reader may also be able to record card swipe characteristics associated with the user. For instance, different users may swipe cards through a card reader in different manners. The registered user account information may be helpful in identifying fraudulent activities because a unique card reader identifier, one or more cards, and/or a user device may be associated with the user. This correspondence may allow for verification of the authentication, which may provide reduced likelihood of card identification theft during an authentication.

During various steps of a user activity, an authentication read may be requested by a third-party entity. The authentication read may be performed by an authentication service system. The data collected by the card reader may be compared with corresponding data from pre-registration data and/or historic data to determine whether the authentication is fraudulent. The registration and/or authentication read may be performed on a user device using a separate mobile application or within the same application used for an authentication.

A method and a system for registering a user for performing a card authentication read are disclosed. The method may comprise (a) verifying an identity of the user in person, comprising reviewing at least one official personal document of the user while face-to-face with the user; (b) providing the user with a card reader having a card reader identifier when the identity of the user is verified in person; (c) receiving pre-registration data for one or more cards of the user through the card reader; and (d) storing the pre-registration data for the one or more cards of the user to be associated with the card reader identifier in memory. The pre-registration data for the one or more cards may comprise (1) a magnetic fingerprint of the one or more cards, or (2) a swipe characteristic of the one or more cards when read by the card reader. The at least one official personal document of the user may be a national passport of the user.

In some embodiments, the pre-registration data for the one or more cards comprises (1) a magnetic fingerprint of the one or more cards, or (2) a swipe characteristic of the one or more cards when read by the card reader. In some cases, the magnetic fingerprint is associated with a distribution of magnetic particles of a magnetic stripe on the card. Ins some cases, the swipe characteristic comprises a speed, direction, angle, timing, or pressure of a swipe as the card is swiped through the card reader.

In some embodiments, verifying the identity of the user further comprises verifying biometric data of the user. In some embodiments, the at least one official personal document of the user is a national passport of the user. In some embodiments, the pre-registration data for the one or more cards are collected with aid of one or more sensors on the card reader. In some embodiments, the card reader is configured to be operably coupled to a user device via a rigid connection or a flexible connection. In some cases, the card reader identifier is generated when the card reader is in communication with the user device. In some cases, a software token is generated for the card reader identifier and sent to the user. In some embodiments, the card reader identifier is contained in a hardware token shipped to the user.

In a separate yet related aspect, a system of registering a user for performing a card authentication read is provided. The system comprises: (i) a communication unit for communicating with a card reader configured to operably couple to a user device, (ii) a memory for storing pre-registration data for one or more cards of the user to be associated with a card reader identifier, and a set of software instructions, and (iii) one or more processors configured to execute the set of software instructions to: receive a detection of a connection between the card reader and the user device; generate a card reader identifier uniquely associated with the card reader in response to the detection; provide the card reader identifier to the user in the form of hardware token or software token; receive the card reader identifier from the card reader or the user device; and store the pre-registration data for the one or more cards of the user to be associated with the card reader identifier and verified user identity information in memory, wherein the pre-registration data for the one or more cards of the user is received through the card reader.

In some embodiments, the pre-registration data for the one or more cards comprises (1) a magnetic fingerprint of the one or more cards, or (2) a swipe characteristic of the one or more cards when read by the card reader. In some embodiments, the card reader is provided to the user when an identity of the user is verified in person by reviewing at least one official personal document of the user while face-to-face with the user.

In another aspect of the invention, a tangible computer readable medium is provided. The tangible computer readable medium is for storing instructions that, when executed by one or more servers, causes the one or more servers to perform a computer-implemented method for registering a user for performing a card authentication read. The method comprises: receiving a detection of a connection between a card reader and a user device; generating a card reader identifier uniquely associated with the card reader in response to the detection; transmitting the card reader identifier to the user in the form of hardware token or software token; receiving the card reader identifier from the card reader or the user device; and storing pre-registration data for one or more cards of the user to be associated with the card reader identifier and verified user identity information in memory, wherein the pre-registration data for the one or more cards of the user is received through the card reader.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example of a process for performing registration for card authentication reads, in accordance with an embodiment of the invention.

FIG. 2 shows an example of a card reader coupled to a user device, in accordance with an embodiment of the invention.

FIG. 3 shows an example of a user device used for performing card authentication reads for various user activities, in accordance with an embodiment of the invention.

FIG. 4 shows examples of cards with corresponding magnetic strips which are used for authentication reads, in accordance with an embodiment of the invention.

FIG. 5 shows examples of various swipe characteristics of cards used for authentication reads, in accordance with an embodiment of the invention.

FIG. 6 shows a schematic system overview of an authentication system, in accordance with an embodiment of the invention.

FIG. 7 shows a schematic system overview of an authentication system with one or more insurance entities, in accordance with an embodiment of the invention.

FIG. 8 shows a schematic system overview of various authentication reads, in accordance with an embodiment of the invention.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides systems and methods for registering for card authentication reads for various user activities (e.g., user account registrations, login processes, or various transactions). Various aspects of the invention described herein may be applied to any of the particular applications set forth below. The invention may be applied as a standalone card reading system or as a component of an integrated transaction or fraud detection software. It shall be understood that different aspects of the invention can be appreciated individually, collectively or in combination with each other.

Various user activities may be conducted online, such as online registrations, login processes, or online transactions, where users may often be anonymous. For instance, users may often register themselves without validation or using minimal personalized information. Users may provide identity information, such as name and identity card number remotely. Users often provide financial information, such as card information remotely. Even if users do personally swipe cards at a card reader, they may be using stolen or skimmed identity information and/or card information.

Systems and methods provided herein provide registration of a user account for an authentication read of a card using a card reader to confirm user identity. For instance a user may receive a card reader in person where a user identity may be verified. A unique card reader identifier of the card reader may be registered to be associated with the user. One or more cards may be further registered using the card reader. During registration, the magnetic fingerprint, which is unique to the card, may be read by the card reader. This may allow the card to be distinguished from skimmed cards, where the data may be duplicated, but the magnetic stripe characteristics may not. Similarly during registration, the swipe characteristics of the card may be read, and may be unique to individual users. Even if the same physical card is used during a transaction, different users may be distinguished from one another by their swipe characteristics. Even for the same user, between multiple swipes, some very slight variation in the swipe characteristics may be expected. If a card swipe is completely identical this may be indicative that registered earlier swipe data was recorded and somehow replayed as subsequent swipe. The card reader identifier, one or more cards, and/or a user device may be registered to be associated with the user. This correspondence may be helpful in identifying fraudulent activities and allow for verification of the authentication reads.

The card reader may be utilized to perform an authentication read of a card. The card reader may collect magnetic fingerprint of a card and swipe characteristics of a user, and provide card reader identifier for secure authentication reads. The collected data may be compared with corresponding data from pre-registered data to determine whether the user activity is fraudulent and/or raise a red flag. The collected data may also be compared with historic authentication reads data. The authentication read may be performed on a user device using a separate mobile application or within the same application used for the user activity. The authentication reads may be requested by a third-party entity and performed by an authentication service system. Alerts may be provided to various parties as needed if certain conditions are detected.

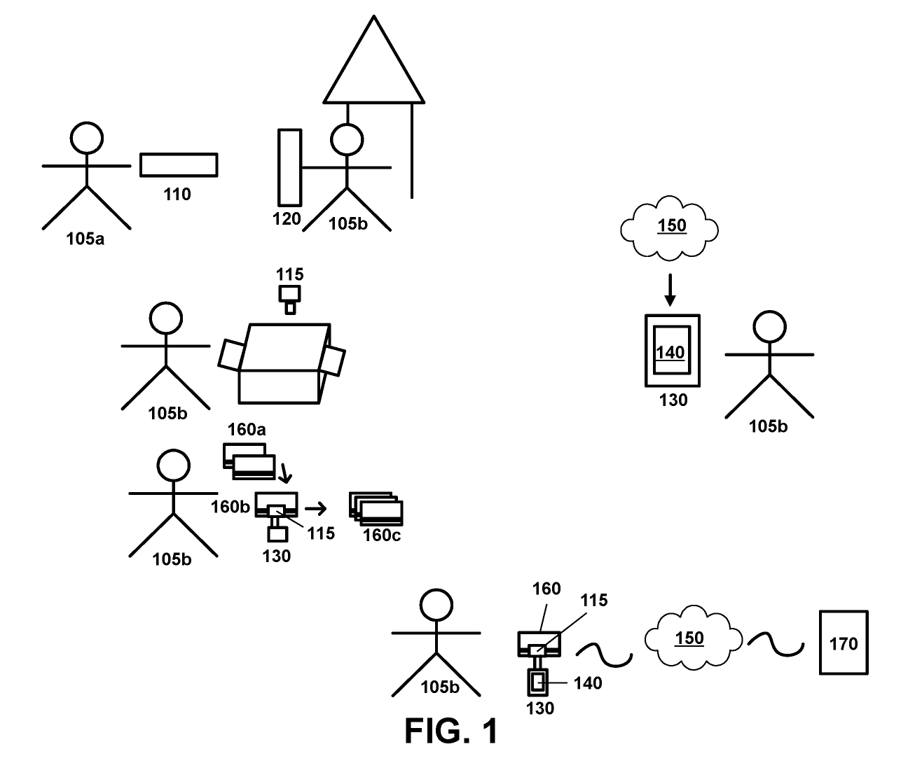

FIG. 1 shows examples of a process for performing registration for card authentication read, in accordance with an embodiment of the invention. In order to perform card authentication reads for various activities, a user (e.g., user 105a, user 105b) may receive a card reader (e.g., included in package 110,120). The card reader may be purchased for a price. Alternatively, the card reader may be given to the user for free. An authentication fee may or may not be charged for every authentication read performed using the card reader. For example, a fee charged per authentication read may be a predetermined fixed fee, such as but not limited to, $0.01, $0.02, $0.03, $0.04, $0.05, $0.06, $0.07, $0.08, $0.09, or $0.10 per authentication read. The fixed fee may be different in different ranges of the authentication read. For example, a fixed fee of $0.01 may be charged for authentication reads for transactions within $1-$100. A fixed fee of $0.05 may be charged for authentication reads for transactions within $100-$1000. Alternatively, the fee may be charged based on a predetermined percentage of each authentication read. For example, the predetermined percentage may comprise, but is not limited to, 0.5%, 1%, 2%, 3%, 4%, 5%, 6%, 7%, 8%, 9%, or 10% of the amount of money involved in the transaction. The fee may be charged to a third-party entity which the user perform the user activity with. Alternatively, the fee may be charged to the user.

The card reader may be received by the user in person (e.g., Step A). For example, the user may purchase the card reader in person at a physical location. For example, the user may purchase the card reader at a post office, a DMV office, a social security office, a city hall, a local government site, a supermarket, a store, or a private site. Alternatively, the user (e.g., the user 105a) may order the card reader online and pick up the card reader (e.g., in package 110) in person at a physical location. For example, the user may pick up the card reader at a post office, a DMV office, a social security office, a city hall, a local government site, a supermarket, a store, or a private site. In yet another embodiment, the card reader (e.g., in package 120) may be delivered to the user (e.g., the user 105b) in person to a physical location. For example, the card reader may be delivered to the user's house, the user's workplace, the user's community center, or any other suitable pre-designated place for in-person delivery. Alternatively, the card reader may be delivered to a storage locker and the user may go to the storage locker to pick up the card reader in person. For example, a person or a machine may be present nearby the storage locker to verify the user's identity as discussed elsewhere in the current disclosure.

Any of the in-person process described herein may require a verification of the user's identity. For example, the user may need to present one or more user identity documents for the verification. The user identity documents may include, but are not limited to, a user's passport, a user's driver's license, a user's insurance card, a user's social security card, a user's birth certificate, a user's banking document, such as a bank statement or a bank card, etc. In some embodiments, a single document or a combination of multiple documents may be needed for the verification. In some embodiments, the in-person process described in the present disclosure requires a human being to check the user identity documents and the user's appearance, or collect biometric data for verification. For example, a person may check the one or more user identity documents to verify the user's identity before giving the card reader to the user. For example, the person may look at the photo on one or more photo ID documents and the user's appearance to make sure the user who picks up the reader device is using his or her own user identity documents. Alternatively or in addition, the person may use a device, such as a scanner or a chip reader, to verify the user's identity documents is valid. For example, the user's passport may be slide through the device to retrieve user identity information for verification. The person who checks the user identity documents may be a salesperson at the store, an administrator at a pick-up location, an officer at a government site, or a delivery person who delivers the card reader to the user's house.

In some embodiments, a person may take advantage of telepresence technology to verify the user's identity. For example, there may be a machine equipped with video camera for the user to communicate with the person located remotely. The person may check the user's identity documents via the machine without requiring the person to be in the same physical location with the user. In some embodiments, the in-person process does not require a human being. For example, a machine may be used at a pick-up location to scan the one or more user identity documents. Additionally, the machine may be able to perform a user's facial recognition or any other biometric scanning function to verify the user identity.

Alternatively or in addition, the verification of the user's identity may comprise performing biometric authentication using one or more biometric characteristics that are unique to each user. The biometric characteristics may comprise, but are not limited to, fingerprint, palm veins/print, face recognition, DNA, hand geometry, iris recognition, retina, odor/scent, collection of body fluid (e.g., blood, tissue sample) or audio characteristics. In some instances, with consent from the user and in pursuance to related privacy policies, an operator may operate a machine (e.g., a scanner, a microphone, etc.) to collect one or more biometric characteristics from the user. The collected biometric identifiers may be compared with corresponding verified biometric characteristics of the user from a reliable source. Alternatively, with consent from the user and in pursuance to related privacy policies, one or more user's biometric characteristics (e.g., the right thumb fingerprint) may be collected when the user orders the card reader, and during in-person pick up, the user may be required to submit the corresponding biometric characteristics for verification. The collected biometric characteristics may need to be completely identical (e.g., 100% match) to the previously stored or verified biometric characteristics to be considered a successful verification. Alternatively, there may be a predetermined threshold of the level of match between the collected biometric characteristics and the previously stored or verified biometric characteristics. For example, if the collected biometric characteristics and the previously stored or verified biometric characteristics match by more than 70%, 75%, 80%, 85%, 90%, 95%, 97%, 99%, 99.9%, 99.99%, then the user identity may be considered verified.

The user's identity documents and biometric authentication may be combined to perform the verification. For example, while ordering the card reader online, the user may be prompted to submit one or more biometric characteristics with consent from the user and in pursuance to related privacy policies. The user's identity may be identified using the collected biometric characteristics from the user. When the user receives or picks up the card reader in person, the user may be required to present one or more identity documents as listed herein to verify the user's identity.

Alternatively or in addition to the in-person identity verification described above, the user identity verification may be performed in other ways. For example, the user may perform the identity verification online. After the user receives the card reader, the user may download a mobile application and install the mobile application on a user device. The user may alternatively visit a website using the user device. The mobile application or the website may be associated with the card reader company. The mobile application or the website may be hosted or maintained by the authentication service. The authentication service may be provided by the card reader company which manufactures and/or distributes the card reader. In some instances, the user may submit user information, such as user name, user birthday, user identity document number (e.g., passport number, driver's license number, or social security number) using the mobile application or website. The user may also submit images or electronic documents of one or more user's identity documents using the mobile application or website. The user information may be transmitted to the authentication service. The user's identity may be verified by the authentication service or other third-party verification system.

The user may be prompted to enter the card reader identifier of the received card reader. Alternatively, the card reader identifier may be obtained when the user device is in communication with the card reader. The user may also be prompted to enter a device identifier of the user device. The card reader company or the authentication service may generate a token for each specific card reader identifier. The token may be hardware token to be shipped to the user separately from the card reader. The hardware token may comprise a USB token, a cryptographic token, a key fob, or other hardware token. The hardware token may need to be connected to the card reader with the corresponding card reader identifier to complete the user identity verification process. The card reader may then be registered to be associated with the user in this process. Alternatively, a software token may be generated for each card reader identifier, and the software token may be sent to a user's email of a verified user. The software token may comprise a string of characters, numbers and/or marks. The software token may be required to be entered within the mobile application or on the website to complete the user identity verification process.

After the user's identity has been verified, the user (e.g., the user 105b) may have access to obtain a card reader (e.g., the card reader 115) (e.g., Step B). For example, the user may unpack the package to obtain the card reader. Alternatively, if there is no packaging of the cared reader, the user may directly obtain the card reader from the in-person delivery or pick-up process as discussed elsewhere herein.

In some instances, the card reader may be registered to be associated with the user (e.g., Step C). For example, the card reader may be registered to be owned by or leased to the user. The card reader registration may be performed in person. The card reader may be assigned with a card reader identifier by the manufacture or seller. The card reader identifier may be associated with hardware or software of the card reader identifier as discussed elsewhere herein. The card reader identifier may be registered to be associated with the user. The card reader identifier may not be alterable by the user or any other person without damaging function of the card reader.

During an in-person registration, the delivery man, the seller, or the administrator may record the association between the user and the card reader identifier. The delivery man, the seller, or the administrator may be associated with the authentication service that issues the card reader and/or provides the card authentication service. Alternatively or in addition, the delivery man, the seller, or the administrator may be third-party personnel. The user may manually input information required for the registration, e.g., user name, user password, card reader identifier, and/or user device identifier. Alternatively or in addition, the person who verifies the user identity may record the required information during in-person registration. The association between the user and the card reader identifier may be stored in an authentication service or other system for future authentication reads during various activities. In some embodiments, all data collected during the in-person delivery and/or registration, such as user identity document information or user biometric data, may also be saved in the authentication service.

Alternatively or in addition to in-person registration, the user may register the card reader by calling the authentication service or a third-party service. During the phone call, user identity information, card reader identifier, and/or other information may be required for the registration. Alternatively or in addition, the user may register the card reader online using a user device. For example, the user may use a user device 130, in conjunction with the card reader, to register the card reader and/or one or more authentication cards to be associated with the user. The user device may also be used to perform authentications, such as card authentication reads to authenticate user identities during one or more activities. The user activities may or may not include the exchange of money, goods, information and/or services. In some embodiments, one or more applications (e.g., a mobile application or a web browser-run application) may run on the user device and displayed on the user interface. For example, the user may download and run a mobile application 140 on the user device to register the card reader with an authentication service (e.g., an authentication server system) through network(s) 150 (e.g., Step C). The mobile application may also be used for registering one or more authentication cards of the user. The mobile application may further be used to perform card authentication reads for various activities. The mobile application may be associated with the authentication service, distributed by the authentication service, and/or operated or maintained using the authentication service. The user device may include a unique user device identifier as discussed in further detail elsewhere in the present disclosure. The user device identifier can be used in combination with the card reader identifier for the registration process and/or the other authentication reads during various activities as discussed elsewhere in the present disclosure.

The card reader may include a unique card reader identifier. The card reader identifier may include various identifying information related to the hardware (e.g., a serial number of the card reader or a component of the card reader), software (e.g., operating system or the mobile application), and/or network communication interface of the card reader. The card reader identifier may be generated when the card reader is registered with or first used with the authentication service. For example, a string of characters may be assigned to the card reader by the authentication service to represent the card reader during future authentication reads using the card reader. Alternatively, the card reader identifier may be generated when the card reader is first in communication with a user device, registered with a user device, or used in combination with a user device for a card authentication read.

The card reader identifier may exist before the card reader is registered to be associated with a user with the authentication service. For example, the card reader identifier may include identifying information of hardware on-board the card reader, and the card reader identifier may be generated during manufacturing and/or testing of the card reader at the manufacture. During registration, the card reader identifier may be identified and retrieved by the authentication service. The card reader identifier may be a permanent identifier associated with the hardware, or an alterable identifier that may be changed when used by different users or registered to be associated with different users. Once a card reader identifier has been generated and/or retrieved, the card reader identifier may be stored to be associated with the user. The card reader identifier may be stored in one or more memory units associated with and/or accessible to the authentication service, the card reader, and/or the user device.

The user may further register one or more cards (e.g., cards 160a, 160b, 160c) with the authentication service using the card reader 115 (e.g., Step D). The cards may include an identity card, a membership card, a credit card, a gift card, a debit card, an insurance card, a library card, or any other types of card. For example, the user may use the mobile application downloaded at Step C for registering the cards. The individual card may comprise a magnetic stripe. Data about the card, card holder, and/or a user account associated with the card may be encoded in the magnetic stripe. The magnetic stripe may further include magnetic fingerprint data which is unique to each card. During registration, the individual card may be swiped through the card reader, such that the data encoded in the magnetic stripe and the magnetic fingerprint data may be collected by the card reader. In some instance in order to distinguish a card swipe for a registration as opposed to a card swipe for a regular card authentication read, the user may provide an affirmative input using the card reader and/or the user device. For example, the user may press a physical button on the card reader, or touch an icon displayed on a display of the card reader to affirmatively indicate this is a registration process instead of a regular card authentication read. This user input may be provided in the mobile application or on the web browser at the beginning of the registration process.

Additionally, swipe characteristics of the user may also be captured by the card reader. During the registration, the data encoded in the magnetic stripe, the magnetic fingerprint data, and/or the swipe characteristics may be collected and stored in one or more memory units associated with or accessible to the authentication service, the card reader, and/or the user device. The data encoded in the magnetic stripe, the magnetic fingerprint data, and the swipe characteristics may be registered to be associated with the user. The data encoded in the magnetic stripe, the magnetic fingerprint data, and the swipe characteristics may also be registered to be associated with the card reader identifier and/or the user device identifier. During registration, the card reader identifier, the user device identifier, the encoded data and magnetic fingerprint related to one or more cards, and/or the swipe characteristics may be stored in various suitable data structures to be associated with the user, such as tables (e.g., hash tables or lookup tables), trees, or graphs.

After the card reader and one or more cards have been pre-registered with the authentication service, the user may use the card reader to complete an authentication read during an activity that requires card authentication (e.g., Step E). For example, the card reader 115 may be connected to the user device 130. The user may swipe a pre-registered card 160 through the card reader to complete an authentication read during the activity. The authentication read may be performed using the mobile application 140 on the user device. The mobile application may or may not be the same used for user registration at Step C. The registration and/or authentication read may be performed on the user device using a separate mobile application or within the same application used for the activity.

The activity may or may not be related to exchange of money, goods, information and/or services with a third-party entity 170 and through network(s) 150. The third-party entity may be an online e-commerce, and a user may perform an authentication read of a credit card to complete a purchase of a product online. Alternatively, the third-party entity may be a broker system, and a user may perform an authentication read of a financial card for verifying transfers of funds between the user's financial account and the broker system. Alternatively, the third-party entity may be a social networking platform which hosts a plurality of user accounts. A user may use the authentication read of a card for verifying the user's identity when registering a user account with the third-party entity. A user may also use the authentication read of a card for verifying user's login to the social networking platform.

During the authentication read, the user may swipe the card through the card reader. Various types of data may be collected during the swipe and used for verification. In some embodiment, the card reader may read data encoded in the magnetic stripe of the card during the swipe. The encoded data in the magnetic stripe may comprise, but is not limited to, a card type, a card number, an expiration date, a card security code, a card holder name, related account information of the card holder, and/or other financial account information. Magnetic characteristics (e.g., magnetic fingerprint) of the card may also be collected during the swipe. The magnetic fingerprint may be related to distribution of magnetic particles and may be unique to each card. The swipe characteristics of the user may be further collected during the swipe. The swipe characteristics may comprise speed of swipe, direction of swipe, angle of swipe (e.g., swipe path), timing of swipe, and/or pressure of swipe associated with the user swiping the card. Greater details about the magnetic fingerprint of cards and swipe characteristics are described elsewhere herein. The magnetic fingerprint data, the encoded data, and the swipe characteristics may be collected and transmitted to an authentication service for verification.

Additionally, when the card reader is in communication with the user device, a card reader identifier may be generated and/or identified. The card reader may be in communication with the authentication service and/or the third-party entity through the user device. Alternatively, the card reader may be in direct communication with the authentication service and/or the third-party entity through the network(s). When the user device is in communication with the authentication service and/or the third-party entity through network(s), a user device identifier may be generated and/or identified. The card reader identifier and/or the user device identifier may be transmitted to the authentication service for verification. The card reader identifier and the user device identifier may be used in combination with or independently from the magnetic fingerprint data, encoded data, and/or the swipe characteristics for verifying the authentication read. Alternatively, the collected data, card reader identifier and/or user device identifier may be stored locally at the card reader and/or the user device, and the authentication read may be performed locally at the card reader and/or the user device.

During the activity, the user may also be prompted to enter personal information. For example, when the user logins into a pre-registered user account, the user may be required to enter the password associated with the user account. Alternatively, when the user swipes the card through the user, the user may be required to enter a pre-set PIN number associated with the card. The entered password or PIN number may be transmitted to an authentication service or a corresponding third-party entity for verification. The entered personal information may be verified independently or in combination with data collected during the swipe to approve or reject the activity.

The authentication read may be requested by an authentication service and/or the third-party entity. For example, the third-party entity may be in communication with the authentication service, and request the authentication service to perform an authentication read for a user activity with the third-party entity. The authentication service may perform the authentication read by comparing the collected data with the pre-registered data and/or historic authentication reads data. The authentication service may return a message indicative of the authentication read result to the third-party entity for approving or rejecting the user activity. The third-party entity may or may not have access to pre-registered data and/or historic authentication reads data associated with the user or a card. The third-party entity may provide an option of performing authentication read to the user, and if the user chooses to perform the authentication read in the user activity, the third-party entity may offer rewards (e.g., cashback or bonus reward points) to the associated user account. The authentication read may also be selected to be mandatory or optional by the user as indicated in user account settings.

The authentication reads may be required for all or certain types of activities. For example, an authentication read may be required only when a transaction involves an amount of money equal to or greater than a predetermined threshold amount. For example, the predetermined threshold amount may be $100, $200, $500, $1000, $5000, $8000, $10,000, $15,000, $20,000. The threshold amount may be determined by the user, an authentication server system, or a third-party entity. In some embodiments, an authentication read may be required when an activity is identified as a high risk activity. For example, the high risk activity may involve suspicious/mismatched user identity associated with the user account, suspicious transaction locations, repetitive entering of wrong user information, and/or flagged user account for previously associated fraudulent activates. In some embodiments, high risk activities may involve high speed transactions, such as requiring for funds to be transferred within a short period of time. In some instances, the use of the further authentication may allow for online activities to occur in situations where previously in-person activity was required. The further assurances of a user's identity may aid in giving entities comfort in permitting larger scale transactions.

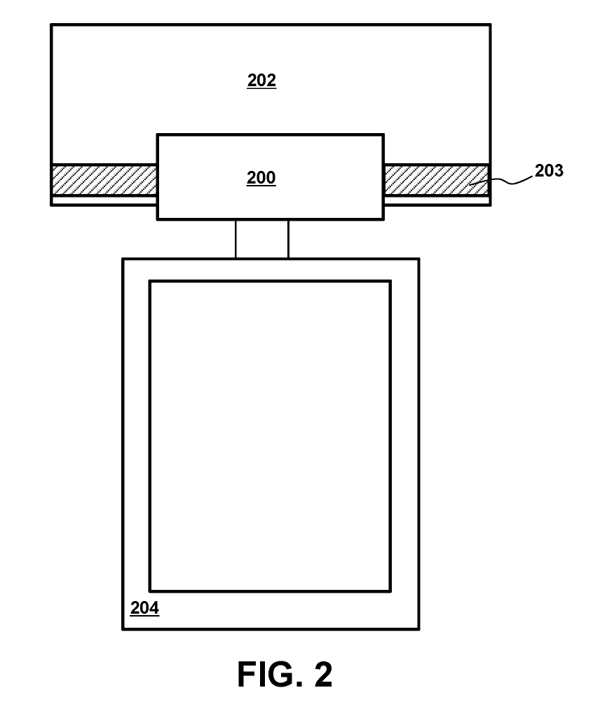

FIG. 2 shows an example of a card reader 200 coupled to a user device 204, in accordance with an embodiment of the invention. The card reader may be physically connected to the user device. Alternatively, the card reader may be in wireless communication with the user device. The card reader may be configured to read a magnetic component (e.g., a magnetic stripe) 203 of a card 202.

The user device may be an electronic device capable of forming a connection or communicating with the card reader. Examples of the user device may include, but are not limited to, a handheld computer, a wearable computing device, a personal digital assistant (PDA), a tablet computer, a laptop computer, a desktop computer, a cellular telephone, a smart phone, an enhanced general packet radio serves (EGPRS) mobile phone, a media player, a navigation device, a game console, a television, a remote control, or a combination of any two or more of these data processing devices or other data processing devices. The user device may be a register at a store or other establishment. The register may be used during user activities (such as financial transactions) at the store or other establishments. The user device may be a network device capable of connecting to a network, such as a local area network (LAN), wide area network (WAN) such as the Internet, a telecommunications network, a data network, or any other type of network.

The user device may have a user device identifier (UDI) that can be unique to each user device. The user device identifier may comprise identifying information that can be used to represent a user device used for authenticating a card read. The user device identifier may comprise a string of characters, which may include a certain number of numerals, a certain number of letters (uppercase letters and/or lowercase letters), a certain number of symbols, or combinations thereof. In some embodiments, the user device identifier may include a serial number of the user device, an international mobile station equipment identifier (IMEI), and/or a mobile equipment identifier (MEID). In some alternative embodiments, the user device identifier may include identifying information of the various chipset or other types of hardware within the user device. Alternatively, the user device identifier may include identifying information of the software (e.g., operating system or software applications) that run on the user device. Alternatively, the user device identifier may comprise identifying information related to the network communication modules (e.g., MAC address).

A user device identifier may be generated when a user device is registered with a third-party entity (e.g., a transaction system), an authentication system, or a transaction entity, or first connects with a third-party entity (e.g., a transaction system), an authentication system, or a transaction entity. A user device identifier may be generated when a mobile application for authenticating a card read is downloaded, installed, or running on the user device for the first time. A user device identifier may be generated when a card reader is first connected to the user device, registered with the user device, or used in combination with the user device for a card read authentication. A user device identifier may be generated when a user account is registered with a third-party entity (e.g., a transaction system), an authentication system, or a transaction entity, and the user device identifier may correspond to the user device used for registration of the user account. In some embodiments, when the user device identifier includes identifying information of hardware on-board the user device, the user device identifier may be generated during manufacturing and/or testing of the user device at the manufacture. In some embodiments, when the user device identifier includes identifying information of software that run on the user device (e.g., an operating system or a web browser), the user device identifier may be generated during downloading, installing or using the software for the first time on the user device. In some embodiments, when the user device identifier includes identifying information related to the network communication interface, the user device identifier may be generated when a corresponding network interface controller is manufactured and/or stored on-board the user device.

Once a user device identifier has been generated, it may be stored with other user account information and/or authentication read information. The user device identifier may be stored in one or more memory units. The user device identifier may be stored in cookies, caches, browsing histories, and/or browser fingerprint. The user device identifier may be stored in a memory on-board the card reader and/or on-board the user device. The user device identifier may be stored on the infrastructure of a third-party entity (e.g., a transaction system), an authentication system, and/or a transaction entity. The user device identifier may be distributed over multiple devices/systems (e.g., peer-to-peer, cloud-computing based infrastructure, between the card reader and an external device), or other device/system of any of the types described herein.

In some embodiments, the user device identifier may be generated on-board the user device and stored on-board the user device, the card reader, an external device, or distributed over multiple devices. In other embodiments, the user device identifier may be generated on-board an external device and may be stored on-board the external device, the user device, the card reader, or distributed over multiple devices. The one or more memory units may include databases. A single copy of the user device identifier may be stored, or multiple copies may be stored. The multiple copies may be stored at different memory units. For instance, the multiple copies may be stored on difference devices (e.g., first copy on-board a card reader, and second copy on-board an external device).

In some embodiments, during a card authentication read, the user device identifier may be transmitted to the card reader when a card reader is connected to the user device. The user device identifier may be transmitted to a third-party entity (e.g., a transaction system), an authentication system, or a transaction entity when the user device is used for authenticating a card read for a transaction. For example, the user device identifier may be transmitted to a third-party entity (e.g., a transaction system), an authentication system, or a transaction entity when a user uses the user device to login to the user account registered at the transaction system, authentication system, or transaction entity.

The user device may comprise memory storage units which may comprise non-transitory computer readable medium comprising code, logic, or instructions for performing one or more steps. The user device may comprise one or more processors capable of executing one or more steps, for instance in accordance with the non-transitory computer readable media. The user device may comprise a display showing a graphical user interface. The user device may be capable of accepting inputs via a user interactive device. Examples of such user interactive devices may include a keyboard, button, mouse, touchscreen, touchpad, joystick, trackball, camera, microphone, motion sensor, heat sensor, inertial sensor, or any other type of user interactive device. The user device may be capable of operating one or more software applications. One or more applications may or may not be related to the operation of the card reader.

The card 202 may be any type of device that may include a magnetic component (e.g., the magnetic stripe 203) that may be used to identify the device. The magnetic component may be printed or layered onto the substrate. The magnetic component may be embedded into the substrate. The card may be a credit card, debit card, gift card, bank card, discount card, membership card, identity card (e.g., driver license), insurance card, or any other type of card. The card may be tied to a user account. The user account may or may not include information about the user (e.g., user identity, user profile data), or any other information pertaining to the user or user account as described elsewhere herein. The user account may also be a financial account for a user that may include information about credits and/or debits of the user.

The data encoded within the magnetic stripe may include information about a card, a user (e.g., a card holder) of the card, or an account associated with the card (e.g., a financial account). The information about the card may include a card type (e.g., credit card, membership card, identity card, etc.), a card issuer (e.g., a credit carrier, a company, the government, etc.), a credit carrier type (e.g., Visa, Mastercard, American Express, Discover, etc.), a card number, a card expiration date, and/or a card security code (e.g., a credit card security code that is usually printed on the back of the card). The information about a user of the card may include information such as the user's name, user's mailing address, user's telephone number, user's email address, user's birthdate, user's gender, user's social security number, one or more user's biometric characteristics, or any other personal information about the user. The information about a financial account associated with the card may include information such as account number, institution for the account (e.g., bank, store, entity, or financial institution), balance information, credit or limit information, or any other information associated with the account.

Each card may also include magnetic fingerprint data. The magnetic fingerprint data may relate to data about a magnetic make-up of the magnetic stripe of the card. This may include information pertaining to remnant noise characteristic information for the magnetic medium of the stripe. Magnetic stripes may include magnetic transitions (e.g., north to south, or south to north). Individual magnetic particles may be provided on the magnetic stripe. There may be inherent variations in orientations of these magnetic particles that may account for magnetic characteristics of the stripe. These magnetic characteristics may form a magnetic fingerprint, which may be substantially unique for each magnetic stripe. One or more cards may be pre-registered with an authentication service using a pre-registered card reader.

The card reader 200 may include a groove or channel through which a card is swiped. In some embodiments, the card reader may include a sensing unit that may be configured to detect the magnetic stripe and obtain magnetic characteristics from the magnetic stripe of the card. The sensing unit may produce a signal indicative of information gathered regarding the magnetic stripe. The information may include data encoded within the stripe and/or magnetic fingerprint data of the stripe.

In other embodiments, the sensing unit may be provided on a side of the card reader, such as an exterior surface of the card reader. The card may be passed or pressed over the side and/or the sensing unit. The card may be held over the side and/or the sensing unit, or may be swiped over the side and/or sensing unit. In some embodiments, the card may be tapped against the card reader such that the sensing unit of the card reader may detect and obtain the encoded data and magnetic fingerprint data from the magnetic stripe. In some embodiments, the card may be present within a detectable range of the sensing unit such that the sensing unit may detect and obtain the encoded data and magnetic fingerprint data from the magnetic stripe.

In some embodiments, a mechanical connection may or may not be formed between the user device and the card reader. An electrical connection may or may not be formed between the user device and the card reader. A communication connection may be formed between the user device and the card reader. For example, the card reader may be connected to the user device via a flexible or a rigid connecting member (e.g., tether, wire, cable) by plugging the connecting member into one or more ports on any side(s) of the user device. The connecting member may be used for exchanging information (e.g., card information, account information, card reader identifier, swipe characteristics, user device identifier) between the card reader and the user device. In some alternative embodiments, the card reader may be in wireless communication with the user device to exchange various information. Various embodiments of the card reader and interaction between the card reader and the user device are described in U.S. Provisional Application 62/204,612 (Attorney Docket No. 48233-701.102), filed on Aug. 13, 2015, the disclosure of which is incorporated herein by reference in its entity.

The card reader may have a card reader identifier (CRI) that can be unique to each card reader. The card reader identifier may include various identifying information related to the hardware (e.g., a serial number of the card reader or a component of the card reader), software (e.g., operating system), and/or network communication interface of the card reader. The card reader identifier may include a string of characters, which may comprise a certain number of numerals, a certain number of letters (uppercase letters and/or lowercase letters), a certain number of symbols, or combinations thereof.

The card reader identifier may be generated when a network communication is established between the card reader and the user device, when the card reader is first connected to a user device, registered with a user device, or used in combination with a user device for a card read authentication. The card reader identifier may be generated when the card reader is registered with a third-party entity (e.g., a transaction system), an authentication system, or a transaction entity. The card reader identifier may be generated when the card reader first connects with a third-party entity (e.g., a transaction system), an authentication system, or a transaction entity. The card reader identifier may be generated when a user account is registered with a third-party entity (e.g., a transaction system), an authentication system, or a transaction entity. In some embodiments, when the card reader identifier includes identifying information of hardware on-board the card reader, the card reader identifier may be generated during manufacturing and/or testing of the card reader at the manufacture. In some embodiments, when the card reader identifier includes identifying information of software that run on the card reader (e.g., an operating system), the card reader identifier may be generated during downloading, installing or using the software for the first time on the card reader. In some embodiments, when the card reader identifier includes identifying information related to the network communication interface, the card reader identifier may be generated when a corresponding network interface controller is manufactured. The card reader identifier may be a permanent identifier associated with the hardware, or an alterable identifier that may be changed when used by different users or registered to be associated with different users.

Once a card reader identifier has been generated, it may be stored in one or more memory units. The card reader identifier may be stored in a memory on-board the card reader. The card reader identifier may be stored on a memory on-board the user device connected with the card reader. The card reader identifier may be stored on the infrastructure of a third-party entity (e.g., a transaction system), an authentication system, or a transaction entity. The card reader identifier may be distributed over multiple devices/systems (e.g., peer-to-peer, cloud-computing based infrastructure, between the card reader and an external device), or other device/system of any of the types described herein.

In some embodiments, the card reader identifier may be generated on-board the card reader and stored on-board the card reader, the user device, an external device, or distributed over multiple devices. In other embodiments, the card reader identifier may be generated on-board an external device and may be stored on-board the external device, the user device, the card reader, or distributed over multiple devices. The one or more memory units may include databases. A single copy of the card reader identifier may be stored, or multiple copies may be stored. The multiple copies may be stored at different memory units. For instance, the multiple copies may be stored on difference devices (e.g., first copy on-board a card reader, and second copy on-board an external device).

During a card authentication read, the card reader identifier may be transmitted to the user device when a card reader is connected to the user device. The card reader identifier may be also transmitted to an authentication service or a third-party entity (e.g., a transaction entity) when the card reader is used for authenticating a card read.

In some instances, the card reader may be powered by the user device. In one example, the power may be provided through a connecting member. In another example, the card reader may be wirelessly powered by the user device through non-radiative or radiative wireless powering. For instance, non-radiative or near-field wireless powering may occur over a short distance by use of magnetic fields (e.g., inductive charging). Radiative or far-field wireless powering may occur using power beaming, such as beams of electromagnetic radiation, such as microwaves or laser beams. Alternatively, the card reader may have its own local power source (e.g., a local on-board power unit) without being powered by the user device. In some embodiments, the card reader may be of a portable size to be easily carried and connected to the user device. The card reader may be a handheld item.

In some embodiments, the card reader may comprise memory storage units which may comprise non-transitory computer readable medium comprising code, logic, or instructions for performing one or more steps. The card reader may comprise one or more processors capable of executing one or more steps, for instance in accordance with the non-transitory computer readable media. The card reader may also include input/output (I/O) interface to permit communication of the card reader with one or more external device (e.g., a user device).

During authentication reads, the card reader may be used to identify a card that is swiped through the card reader and/or a user associated with the card. In some instances, the identification of the card may include verification of an asserted identity of a card and/or user, based on pre-registered data. In other instances, the identification of the card may include determining an identity of the card and/or user without a previous assertion, based on pre-registered data or historical authentication reads data. A card may be swiped through the card reader for the identification. The identification of the card may occur for any purpose, which may or may not include the facilitation of an authentication read. In some instances, the identification may occur to allow a user access to information or a place. Rather than just entering a card number or other card information on a user display of the user device, the card may be read by the card reader. The relevant information may be read from the card via the card reader and used to perform the identification. The card reader may be communicating with a user device that may be facilitating the identification. The user device may receive the card information from the card reader and aid facilitating the identification process. The identification may occur online or have an online component. The card reader may provide an additional level of security compared to entering in card information manually.

The card reader may be used to facilitate authentication reads. In some instances, the card may be swiped through the card reader when a user activity (e.g., a user identity authentication or a financial transaction) is occurring. Rather than entering a card number or other card information on a user display of the user device, the card may be read by the card reader to retrieve the relevant information for the authentication read. The relevant information may be read from the card via the card reader and used to perform the authentication read. The card reader may be communicating with a user device that may be facilitating the authentication read. The user device may receive the card information from the card reader and aid facilitating the authentication read. The activity may be an online activity, such as an online transaction. The activity may be an in-person activity with an online component (e.g., verifying the card information, account information, or user information). The card reader may provide an additional level of security compared to entering in card information manually. An authentication read for the card may optionally be performed when the card is read by a card reader. The authentication read may result in obtaining a magnetic fingerprint and/or swipe characteristics for the card. This information may be useful in authenticating the card, the user, and/or the user activity, as described in greater detail elsewhere herein. The authentication may be permitted to be completed, may be stopped, or may cause additional verification processes to occur, based on the authentication read.

The wireless communications may include two-way wireless communications between the card reader and the user device. Data may flow from the card reader to the user device and/or data may flow from the user device to the card reader. For instance, information about a card authentication read by the card reader may be transmitted from the card reader to the user device. The user device may have a communication unit and/or the card reader may have a communication unit that may permit wireless communications between the two devices. A communication unit may optionally include an antenna. In some embodiments, a component or dongle may be plugged into the user device that may permit the wireless communication between the user device and the card reader. The component or dongle may include a communication unit that may communicate with a communication unit of the card reader.

As discussed elsewhere herein, by pre-registering the card reader and one or more cards, the card reader identifier, magnetic fingerprint data and data encoded in the card, and swipe characteristics may be stored to be associated with the user such that these data can be used for verifying authentication reads during various user activities.

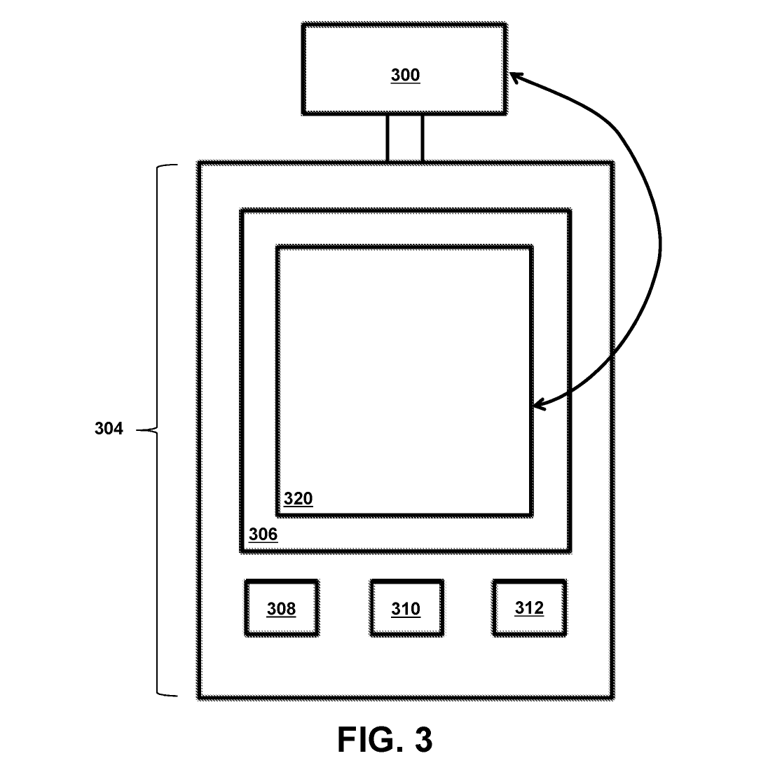

FIG. 3 shows examples of a user device 304 used for performing card authentication reads for various user activities, in accordance with an embodiment of the invention. In some embodiments, the user device may be in network communication with a card reader 300 using a wired connection or wirelessly. The user device 304 may have one or more characteristics of the various embodiments of the user device described elsewhere herein.

Examples of the user device may include, but are not limited to, a handheld computer, a wearable computing device, a personal digital assistant (PDA), a tablet computer, a laptop computer, a desktop computer, a cellular telephone, a smart phone, an enhanced general packet radio serves (EGPRS) mobile phone, a media player, a navigation device, a game console, a television, a remote control, or a combination of any two or more of these data processing devices or other data processing devices.

The user device may include one or more processors 308, memory 310, one or more network interfaces 312, and one or more communication buses (not shown) for interconnecting these components (e.g., a chipset). The user device may also include a user interface 306. The user interface may include one or more output devices that enable presentation of media content, such as one or more visual displays and/or one or more speakers. The user interface may also include one or more input devices for facilitating user input, such as a touch screen display, a touch-sensitive input pad, a camera, a gesture capturing camera, a microphone, a keyboard, or other input buttons or controls. One or more applications (e.g., a mobile application or a browser-run application 320) may run on the user device and displayed on the user interface.

The memory 310 may include high-speed random access memory, such as DRAM, SRAM, DDR RAM, or other random access solid state memory devices. The memory may optionally include non-volatile memory, such as one or more magnetic disk storage devices, one or more optical disk storage devices, one or more flash memory devices, or one or more other non-volatile solid state storage devices. The memory may include one or more storage devices remotely located from one or more processors 308. The memory may include a non-transitory computer readable storage medium which stores various programs, modules, and data structures related to the operating system, network communication modules, display modules, request handling modules, and/or data processing modules. The memory may also include databases for storing various information including but not limited to, pre-registered card reader identifier, pre-registered data (e.g., encoded data, magnetic fingerprint data, and/or swipe characteristics) for one or more cards of the user, account information of the user, device information, historic activity data, and/or usage data associated with the user of the user device (e.g., other activity data associated with the user).

A mobile application 320 may be run on the user device for registering the card reader. For example, the mobile application may be associated with an authentication service, as described in any of the embodiments provided herein. The mobile application may be distributed by the authentication service and/or may be operated or maintained using the authentication service. After the user receives a card reader, the user may download and run the mobile application on the user device. During registration (or pre-registration), the user may connect the card reader with the user device. A card reader identifier may be generated or retrieved to represent the card reader in authentication reads for various activities. The card reader identifier may be stored in one or more memory units associated with or accessible to the card reader, the user device, and/or the authentication service. The mobile application may also be used for registering one or more cards using the card reader. For example, each card may be swiped through, pressed over, tapped over, or shown in detectable range of the card reader. The card reader may collect the encoded data, magnetic fingerprint data, and/or swipe characteristics of the user associated with each card. The collected data may be stored in one or more memory units associated with or accessible to the card reader, the user device, and/or the authentication service. During registration, the device identifier may also be generated or retrieved and stored in one or more memory units associated with or accessible to the card reader, the user device, and/or the authentication service. The collected data, the card reader identifier, and the user device identifier may be stored to be associated with the user for verifying authentication reads during various activities.

A mobile application may also be run on the user device for performing the authentication read during an activity. The mobile application for performing the authentication read may or may not be the same as the mobile application for registration. During an activity that requires authentication read, the mobile application may be prompted to be run on the user device. A notification may be displayed within the application to request for an authentication read. After a pre-registered card is swiped through the card reader, the collected data may be verified by a comparison with the pre-registration data and/or historic activity data. The mobile application may facilitate the operation of a card reader in communication with the user device. The mobile application may allow the collection and/or transmission of data using the card reader. The mobile application may be able to detect a card reader identity and/or user device identity.

In some embodiments during a user activity, without switching the user interface, the authentication read can be performed within the same user interface for the activity. In some examples, during a transaction performed on a merchant's website or within a merchant's application, or during a user account login process onto a social network service, an authentication read may be required. Instead of opening a separate application, an in-app authentication tool within the merchant's application or the social network service application, or an integrated authentication tool on the merchant's website or the social network service website may be used for the authentication read.

In some embodiments, the user device may store card reader identifying information of one or more card readers that have interactions with the user device. For example, by detecting a network communication being established between the card reader and the user device, the user device may automatically retrieve and store the card reader identifier of the card reader. The user device may store the card reader identifier to be associated with user account, card information, and/or swipe characteristics obtained for the current card authentication read.

The mobile application may be downloaded from an online store and installed on the user device. For example, during an initial login to use the mobile application by a user, a user account registration may be required. During the user account registration, various user account information may be mandatorily or optionally requested from the user. The user account information may include, but is not limited to, user's name, user's mailing address, user's telephone number, user's email address, user's birthdate, user's gender, user's social security number, user account login ID and password.

During the initial user account registration, one or more cards of the user may be registered to be associated with the user account. For example, the card information of each card may include a card type, a card issuer, a credit carrier type (e.g., Visa, Mastercard, American Express, Discover, etc.), a card number, a card expiration date, and/or a card security code. In some embodiments, the one or more cards may be requested to swipe through the card reader during the registration process, such that the encoded data in the magnetic stripe, the magnetic fingerprint data, and/or the swipe characteristics associated with the user can be obtained and stored. Additionally, the card reader identifier can also be retrieved from the card reader and stored on the user device. These types of registration information can form bases for secure authentication reads for various future activities.

A user may use the user device to perform a user activity (e.g., a user login process or a transaction) associated with a third-party entity which requires an authentication using a mobile application or a web browser on the user device. During the authentication read, a separate mobile application for a secure authentication read may be prompted to open on the user device. This separate mobile application maybe hosted by the authentication server system or other third-party entity (e.g., a credit card company) as described in various embodiments elsewhere herein. The mobile application for secure authentication read may be displayed in parallel with or overlaid on the mobile application for the activity on the same user interface. Alternatively, the mobile application for the activity may be switched to the mobile application for secure authentication read to perform the authentication read. Alternatively, the secure authentication may be performed within the same user interface for the activity. For example, instead of opening a separate application or switching the user interface, an in-app authentication tool within the merchant's application, or an integrated authentication tool on the merchant's website may be used for the secure authentication.

A notification may be displayed within the application to request for a secure authentication. After the card is swiped through the card reader connected to the user device, the collected data may be analyzed and compared with the historic activity data as described in various embodiments elsewhere herein.

The user device may have a unique user device identifier (e.g., UDI) that distinguishes the user device from any other devices. As discussed previously, the user device identifier may include a serial number of the user device, an international mobile station equipment identifier (IMEI), a mobile equipment identifier (MEID), identifying information of the various chipset within the user device, identifying information of the network communication modules (e.g., MAC address), and/or other suitable device identifiers. During the registration process, the user device identifying information may be associated with the user account, the one or more cards of the user, card reader identifier, and/or other data. The registration data may be used for verifying authentication reads during various activities. The generation and/or storage of the user device identifying information may have one or more characteristics of various embodiments of the user device described elsewhere herein. As further discussed elsewhere herein, the match or mismatch between the user device identifying information and other data related to an authentication may be used for determining whether an authentication read for an activity is a fraud.

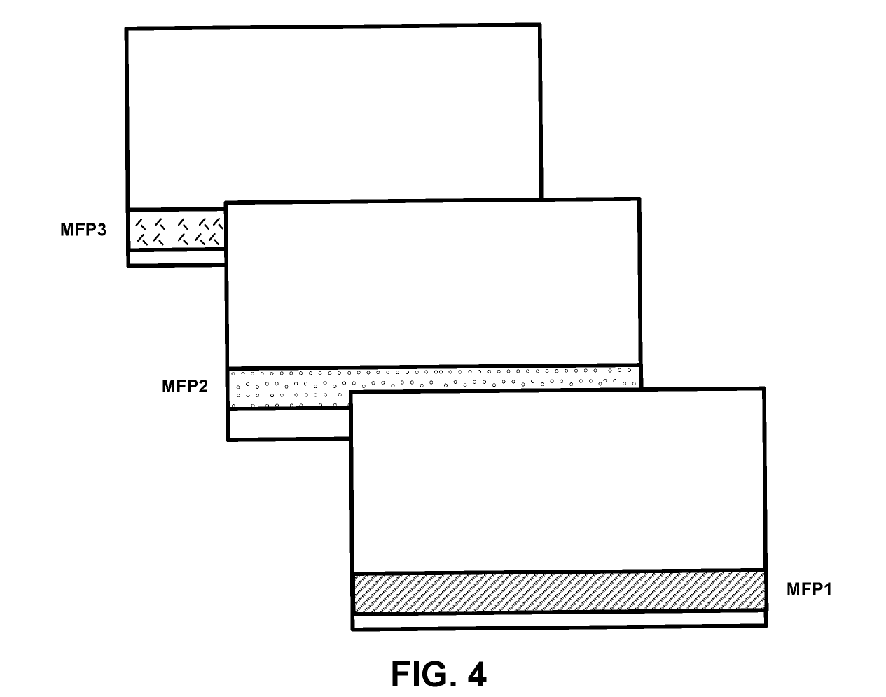

FIG. 4 shows examples of cards with corresponding magnetic strips which are used for authentication reads, in accordance with an embodiment of the invention. In some embodiments, the magnetic stripes of cards may be provided in accordance with one or more international or national standard. Data may be recorded in tracks on the magnetic stripe. In some examples, the magnetic stripe may be provided in a typical format of track two of an Internal Standards Organization (ISO) 7811 card. In alternative embodiments, track one or track three standards may be used. In some instances, track two (e.g., having 75 bpi) may be preferable by having a lower density than track one or track three. A track may optionally have a plurality of sections, such as LZ, SS, PAN, ES, LRC, and TZ. A wide variety of formats may be utilized in the systems and methods described herein.

The magnetic stripes may have a standardized placement on the card. The magnetic stripes may include a magnetic medium deposited or layered on a substrate of the card. The magnetic stripes may be attached to the card with aid of an adhesive. The magnetic stripes may be read with aid of a card reader.

The magnetic stripes may include magnetic transitions (e.g., north to south, or south to north). The transitions may be detected and the pattern of transitions may be useful for encoding information. The magnetic stripes may be made from individual magnetic particles. There may be inherent variations in an orientation of these magnetic particles that may account for magnetic characteristics of the stripe. These magnetic characteristics may form a magnetic fingerprint, which may be substantially unique for each magnetic stripe (e.g., magnetic fingerprint MFP1, MFP2, MFP3 for each card). Each magnetic stripe of each magnetic card may have a different distribution of magnetic particles, and correspondingly have different magnetic characteristics. Thus, for each magnetic stripe, a different magnetic fingerprint may be generated. This may permit magnetic stripes to be distinguished from one another.

Magnetic stripes may have data encoded therein. While an individual may read and/or duplicate the data encoded in the magnetic stripe, an individual may not be able to exactly copy the distribution of magnetic particles in the magnetic stripe. Thus, if a fraudster were to try and clone a card by copying the data encoded in a first card, onto a second card, the fraudster would still not be able to duplicate the magnetic fingerprint of the first card in the second card. The first magnetic stripe in the first card may have its own magnetic characteristics based on the distribution of individual magnetic particles, which cannot be readily duplicated in a second magnetic stripe of a second card. Thus, even if data encoded in the cards were duplicated, the magnetic fingerprints of each card based on the physical magnetic particles could not be duplicated. Thus, an individual card may be identified and/or distinguished from other cards based on the magnetic fingerprint. As discussed elsewhere herein, the magnetic fingerprint data and other encoded data in the magnetic stripe may be collected and stored during pre-registration process. Various embodiments of cards with corresponding magnetic strips are described in U.S. Provisional Application 62/204,612 (Attorney Docket No. 48233-701.102), filed on Aug. 13, 2015.

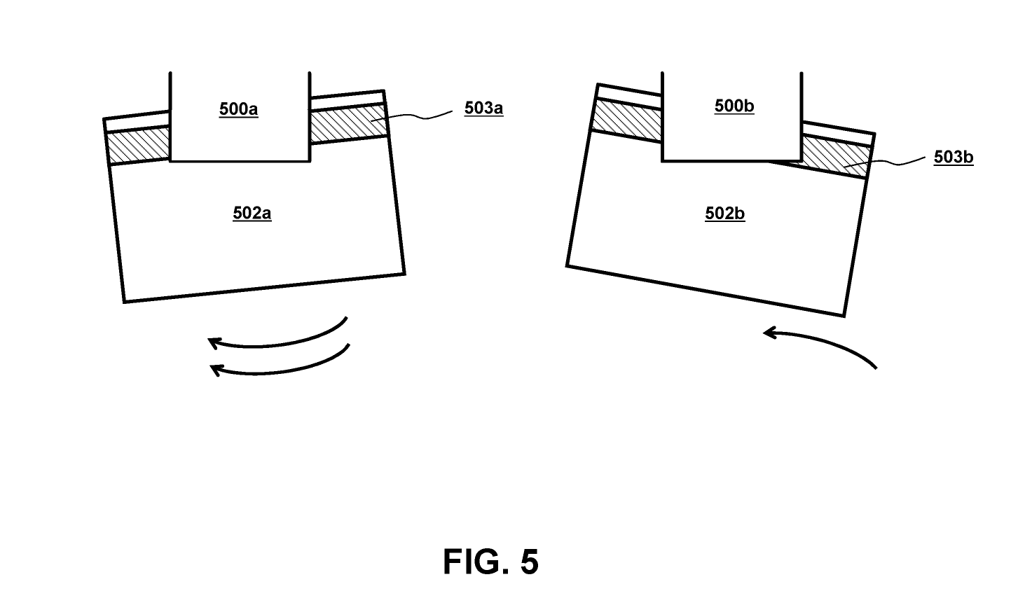

FIG. 5 shows examples of various swipe characteristics of cards used for authentication reads, in accordance with an embodiment of the invention. Cards 502a, 502b may be read by card readers 500a, 500b respectively. Each payment card may have a magnetic stripe (e.g., a magnetic stripe 503a, 503b) which may be read by the respective card reader. The cards, magnetic stripes, and/or card reader may have one or more characteristics of various embodiments described elsewhere herein.

During registrations of one or more cards, the card reader may read the magnetic stripe to collect information when each card is swiped through a card reader. For example, the information may include identifying information for the card (e.g., magnetic fingerprint data, carrier, card number, user name, etc.). Additionally, swipe characteristics associated with the user may be captured by the card reader during the swipe. During a user activity, an authentication read of a pre-registered card may be occurring while the swipe is occurring. The authentication read may include collecting magnetic fingerprint data of the card and/or swipe characteristics associated with the user. The swipe characteristics may be determined based on data collected using a magnetic head of the card reader.

Examples of swipe characteristics may include speed of swipe, direction of swipe, angle of swipe (e.g., swipe path), timing of swipe, and/or pressure of swipe. Different users may have a tendency to swipe cards in different manners. For example, a first user may have a tendency to swipe a card very quickly while a second user may swipe a card more slowly. In another example, first user may have a tendency to swipe a card from left to right, while a second user may have a tendency to swipe from right to left. Such swipe characteristics may be useful for identifying a user that is swiping the card. For instance, if Card A belongs to User A, who always swipes quickly and from left to right, and then an authentication read is conducted using Card A where the individual swipes slowly and from right to left, it may be possible to identify that the individual is likely not User A.

The card reader may be capable of detecting a speed of a swipe. For instance, users may swipe cards at various speeds. For instance, as shown in Scenario A, the card 502a may be moving quickly as denoted by the double arrows, while in Scenario B, the card 502b may be moving more slowly, as denoted by the single arrow. The card reader may be able to distinguish speeds of card swipes on the order of tens of meters per second, meters per second, 1 meter/second, tens of centimeters per second, centimeters per second, millimeters per second, tenths of millimeters per second, hundredths of millimeters per second, or micrometers per second. For instance, if the card reader can distinguish the speed of the card swipe on the order of centimeters per second, the card reader can distinguish when a first user may swipe a card at 5 cm/s and a second user may swipe a card at 7 cm/s. The card reader may optionally measure the actual swipe speed of the card. The swipe speed may be precise on the order of tens of meters per second, meters per second, 1 meter/second, tens of centimeters per second, centimeters per second, millimeters per second, tenths of millimeters per second, hundredths of millimeters per second, or micrometers per second. For instance, a card swipe of 10.27 cm/s may be measured when the precision is on the order of tenths of millimeters per second.

The card reader may be capable of detecting a direction of a swipe. For instance, users may swipe in various directions. For instance, if the card reader includes a groove that is horizontally oriented, a user may swipe from the left to the right, or from the right to the left. If the card reader includes a groove that is vertically oriented, a user may swipe from up to down, or from down to up. Regardless of whether the card reader has a groove or any other region that reads a magnetic stripe of a card, the user may be capable of swiping the card in a first direction, or in a second direction substantially opposing the first direction. The card reader may be able to detect which direction the card was swiped.

The card reader may be able to detect angle of swipe (e.g., swipe path). For example, the card may be tilted relative to the card reader or may be parallel relative to the card reader. For instance, as shown in Scenario A, a card 502a may be angled so that the leading edge in a swipe is angled away from the card reader, while the trailing edge in a swipe is angled toward the card reader. Scenario B presents a situation where the card 502b may be angled so that the leading edge is angled toward the card reader while the trailing edge may be angled away from the card reader. In some scenarios, the card may be parallel relative to the card reader so that the leading edge and the trailing edge are identically angled relative to the card reader. The card reader may be capable of detecting an angle of swipe or an angle of a position of a card relative to a card reader on the order of multiple degrees, single degrees, tenths of degrees, hundredths of degrees or thousandths of degrees. For instance, a card may be tilted a greater than, less than, or equal to, about 45 degrees, 40 degrees, 35 degrees, 30 degrees, 25 degrees, 20 degrees, 15 degrees, 10 degrees, 5 degrees, 4 degrees, 3 degrees, 2 degrees, 1 degree, 0.5 degrees, 0.1 degrees or 0 degrees relative to the card reader. An angle of the card relative to the card reader may remain the same throughout the swipe or may be variable throughout the swipe. The angle at each point in the swipe may optionally be measured.

The swipe path of the card may be measured. This may include the curvature, angle, and/or distance of how the card is swiped relative to the card reader. For instance, as illustrated in Scenario A, the swipe path may be curved so that the inner part of the curve is facing toward the card reader 500a. Scenario B illustrates a swipe path that may be curved so that the inner part of the curve is facing away from the card reader 500b. In some instances, the swipe path may be straight without having any curvature. The degree of curvature of the path may be measured. The changes in curvature value over the swipe path may be measured. Any details of the swipe path itself, e.g., the position and/or orientation of the card relative to the card reader at any point in time of the swipe may be detected by the card reader and/or recorded.

A position of a card relative to the card reader may be detected. For example, some users may press a card deep within a groove when swiping the card so that the magnetic stripe of the card is as deep within the groove as possible. Other users may not press so deeply so that there may be some space between the card and the deepest part of the groove. This may affect the placement of the magnetic stripe relative to a magnetic sensor. In some instances, the lateral displacement (e.g., depending on how deep the card is within the groove, lateral being perpendicular to the main direction of swipe) of the magnetic stripe relative to the magnetic sensor over time may be determined.

A card reader may be capable of detecting timing of swipe. The timing of the swipe may relative to the total time it takes to swipe a card. The timing of the swipe may be related to the velocity of the swipe. The timing of the swipe may also relate to the timing of each component of a swipe path. The positions/orientations of the card may be sampled continuously. In some instances, the positions/orientations of the card may be sampled at regular or irregular time intervals. The time intervals may be on the order of every 10 seconds, 5 seconds, 3 seconds, 2 seconds, 1 second, 0.8 seconds, 0.5 seconds, 0.3 seconds, 0.2 seconds, 0.1 seconds, 0.08 seconds, 0.05 seconds, 0.03 seconds, 0.01 seconds, 0.008 seconds, 0.005 seconds, 0.003 seconds, or 0.001 seconds, or less. Such sampling frequency may be greater than, less than, or equal to any of the values described. The sampling frequency may be preset or may be variable. A user may be able to predetermine the sampling frequency. A sampling frequency may be altered based on a detected magnetic stripe based on the characteristics of the magnetic stripe.

A card reader may be able to detect pressure of swipe. For example, the card reader may be able to detect whether the magnetic stripe is rubbing hard against the magnetic sensor of the card reader or whether it is pressed more lightly against the magnetic sensor. In some instances, a gap may be provided between the card and the magnetic sensor. In some instances, the size of the gap may be measured and/or distinguished by the card reader.

One, two, three, or more swipe characteristics may be detected using the card reader. When multiple swipe characteristics are considered in combination, one or more of the swipe characteristics may be equally or unequally weighted. For example, some swipe characteristics may have a greater variability, even if the same user performs the swipe, relative to other swipe characteristics. The swipe characteristics that may have a lower weight than a swipe characteristic that tends to have lower variability. In some instances, thresholds of comparisons may be provided. The swipe characteristics that have a greater variability may have a lower threshold than a swipe characteristic that has a lower variability. Thus, a set of user swipe characteristics may be analyzed.

During registrations of one or more cards, various swipe characteristics may be captured. For example, the speed of swipe, direction of swipe, angle of swipe (e.g., swipe path), timing of swipe, and/or pressure of swipe may be captured during the registration. In some instances, the user may be requested to swipe a card for multiple times (e.g., three, four, five, or six times) such that the card reader may capture a range of the speed, direction, angle, timing, and/or pressure of the swipe among the multiple times of swipes. An average or the captured range may be stored to be associated with the user for verifying the authentication read. The one or more swipe characteristics may be stored as a hash of the collected data or a string of numerous characters generated based on the collected raw data.

During one or more user activities, a user may be identified and/or distinguished from other users based on collected swipe characteristics. This may be independent of whether the card that is being swiped is identified as being a particular card, or authorized as being a particular card. The user may be identified based on swipe characteristics independent of whether the card itself is flagged from fraud. In some instances, a card may be identified as the original card, but the user may be flagged as potentially not being an authorized user based on the swipe characteristics.

In some embodiments, the collected swipe characteristics may need to be completely identical to the previously stored set(s) of swipe characteristics (e.g., registered data) to be considered a match (e.g. 100% match). Alternatively, the collected swipe characteristics may be considered a match when the collected data is within the registered swipe data range. Alternatively, the collected swipe characteristics may be considered a match when the collected data and the registered swipe data match by more than 70%, 75%, 80%, 85%, 90%, 95%, 97%, 99%, 99.9%, 99.99%. In some instances, a perfect 100% match may be suspicious. For instance, each time a user swipes a card, there is likely to be some minor variation. Physically it is extremely unlikely that an individual swipe a card with exactly the same swipe characteristics. Having the exact same characteristics may be an indicator of a type of replay attack. For instance, a previous swipe could have been recorded, including the magnetic fingerprint and the swipe characteristics, and the previously recorded swipe may be played back as if it were occurring in real time.

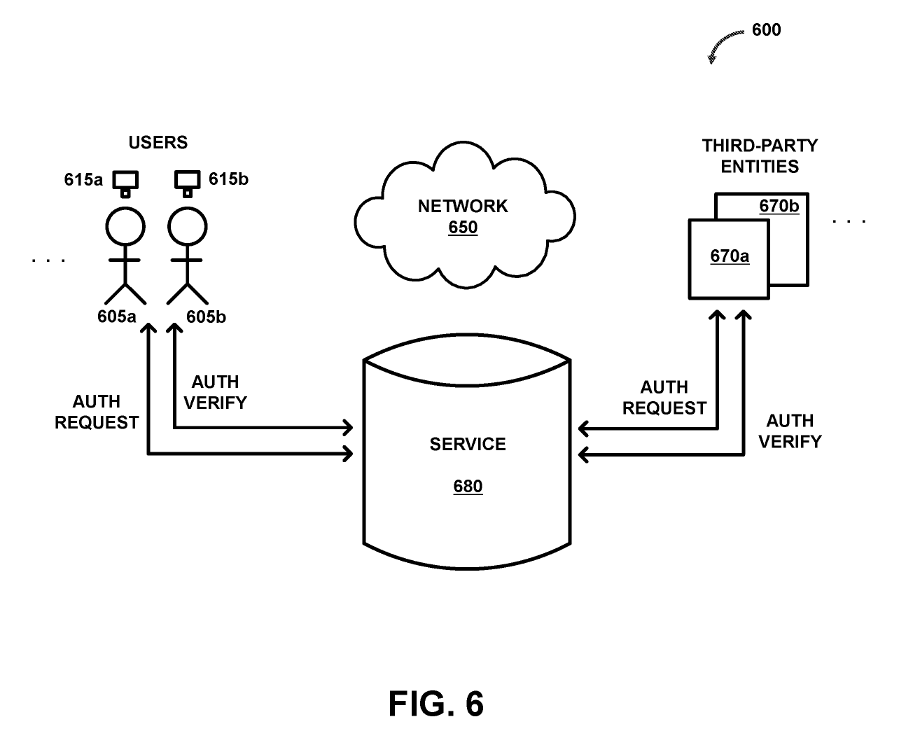

FIG. 6 shows a schematic authentication system 600 illustrating various authentication reads, in accordance with an embodiment of the invention. Authentication reads may be performed for various activities which may or may not include the exchange of money, goods, services, and/or information. The activities may include any situation where a user may swipe a card. An authentication read may include verification of a user's card and/or a user's identity. An authentication read may relate to whenever an authentication read of a card may occur.

The authentication system 600 may include one or more card readers 615a, 615b associated with respective users 605a, 605b, an authentication service 680 (e.g., a server system configured to provide card authentication read service), one or more third-party entities 670a, 670b (e.g., a merchant's system, a broker's system, a social networking platform, or other entity requiring authentication card reads), and communication network(s) 650 for providing communications between these components. In some instances, the authentication system may also comprise one or more user devices (not shown) in communication with respective card readers. The respective users may perform various activities and authentication reads using a user device. For example, a card authentication read may be facilitated by a user interface of the user device as discussed elsewhere in the present disclosure. The user may swipe a card (not shown) through the corresponding card reader to register the card reader and the card. The user may also swipe the registered card through the card reader to perform authentication reads in various activities.

The communication network(s) may include local area networks (LAN) or wide area networks (WAN), such as the Internet. The communication network(s) may comprise telecommunication network(s) including transmitters, receivers, and various communication channels (e.g., routers) for routing messages in-between. The communication network(s) may be implemented using any known network protocol, including various wired or wireless protocols, such as Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocols.

The user devices (not shown) may include one or more characteristics of the various embodiments of the user devices described elsewhere herein. In some embodiments, a user device may include one or more processors configured to handle various requests from the user, the card reader, the authentication service, and/or the third-party entity. The user device may also include or have access to one or more databases for storing various information including but not limited to, registration information, authentication read information, pre-registered card information (e.g., encoded data, magnetic fingerprint data, and/or swipe characteristics) of one or more cards of the user associated with the user device, pre-registered account information of the user associated with the user device, pre-registered device information of the user device, pre-registered device identifier of card reader(s) which may have interactions with the user device, historic authentication reads data, and/or usage data associated with the user of the user device (e.g., other activity data associated with the user). Various types of user devices may be used to facilitate an authentication read for a user activity. An authentication system may include multiple types of user devices that may be used simultaneously.

The card readers 615a, 615b may include one or more characteristics of the various embodiments of the card readers described elsewhere herein. For example, a card reader may include one or more processors configured to handle various requests. In one instance, the user may send a request for performing an authentication read for a user activity by pressing a button or touching an icon on the card reader. The card reader may be in communication with and capable of handling requests from a user device, the authentication service, and/or the third-party entity. The card reader may also include or have access to one or more databases for storing various information including but not limited to, pre-registered card information (e.g., encoded data, magnetic fingerprint data, and/or swipe characteristics) of one or more cards of the user associated with the card reader, pre-registered account information of the user associated with the card reader, pre-registered device information of the user device(s) which may have interactions with the card reader, pre-registered device identifier of the card reader, historic authentication reads data using the card reader, registration data registered using the card reader, and/or usage data of the user associated with the card reader.

A user may obtain a card reader as discussed elsewhere herein. For example, user identity of a user may be verified before obtaining a card reader. The obtained card reader may be registered to be associated with the user as discussed elsewhere herein. For example, the card reader may be registered to be owned by or leased to the user. The card reader registration may be performed in person or online facilitated by a user device in communication with the card reader. The card reader may be assigned with a card reader identifier, and the card reader identifier may be registered to be associated with the user and/or a user device of the user. For example, the card reader identifier may be registered to be associated with a user account, a user name, a user password, and/or other user information.

The card reader can connect with or communicate with various types of user devices. The various types of user devices may include, but are not limited to, a handheld device, a wearable device, a mobile device, a tablet device, a laptop device, a desktop device, a computing device, a telecommunication device, a media player, a navigation device, a game console, a television, a remote control, or a combination of any two or more of these data processing devices or other data processing devices. The card reader may connect with the user devices wirelessly or using wired connections. In some instances, a single card reader may be in communication with a single user device or multiple user devices simultaneously. In some instances, a single user device may be in communication with a single card reader or multiple card readers simultaneously.

An authentication service 680 may be configured to perform authentication reads as required by various user activities as discussed elsewhere herein. The authentication service may also be configured to register users, card readers, user devices, and/or cards associated with respective users for authentication reads. The authentication service may store and/or have access to various information including but not limited to, user identity and activity data of registered users, authentication information, card information (e.g., encoded data, magnetic fingerprint data, and/or swipe characteristics) of one or more pre-registered cards of the user, device information of one or more user devices associated with the user, account information of the user, card reader identifier of card reader(s) registered to be associated with the user, historic authentication data, and/or usage data associated with the user (e.g., other activity data associated with the user). The authentication service may request and perform the authentication card read during a user activity. Alternatively, the authentication service may perform the authentication card read in response to a request from a user or a third-party entity (e.g., a transaction entity, a social network service, a government service, etc.) The authentication service may also be configured to perform other functionalities.

The various functionalities of the authentication service may be facilitated by use of one or more processors. The authentication service may be facilitated by and/or have access to one or more databases. The authentication service may be implemented on one or more standalone data processing apparatuses. Alternatively, the authentication service may be implemented on one or more processing apparatuses and/or databases offered by a distributed network of computers (e.g., peer-to-peer or cloud-computing based infrastructure). One or more functionalities of the authentication service may be part of a server or accessed by a server. The authentication service may be in communication with one or more user devices and/or one or more card readers 615a, 615b. The authentication service may be in communication with various user devices and/or card readers with aid of a communication unit (e.g., an I/O interface). The authentication service may be in communication with various external server systems (e.g., merchant's system, broker's system, credit card companies, social network platforms, and/or other entities). The authentication service may be in communication with various external server systems with aid of one or more I/O interfaces. The I/O interface to the user devices and/or the card readers may facilitate the processing of input and output associated with the user devices and/or the card readers respectively. For example, the I/O interface may facilitate the processing of a user input associated with a request for secure authentication. The I/O interface to external server systems may facilitate communications with one or more third-party entities (e.g., merchant's system, broker's system, credit card companies, social network platforms, and/or other third-party entities).

Communications in authentication system 600 can be directed between the authentication service and one or more user devices (not shown). In some instances, communications can also be directed between the authentication service and the one or more card readers (e.g., the card readers 615a, 615b). Alternatively, communications between the authentication service and the card readers can only be conducted through the corresponding user devices (not shown).

The authentication service system may comprise memory storage units which may comprise non-transitory computer readable medium comprising code, logic, or instructions for performing one or more steps. The one or more processors of the authentication service system may be capable of executing one or more steps, for instance in accordance with the non-transitory computer readable media. In some embodiments, the one or more processors may generate or receive requests for performing secure authentication reads, processing the requests, identifying information needed for the authentication reads, performing the authentication reads, and returning the authentication results in response to the requests. The one or more databases may store various information, including but not limited to, pre-registered card information, pre-registered account information associated with each user, pre-registered device information of the user device (e.g., a user device identifier), the pre-registered card reader (e.g., a card reader identifier), historic authentication reads data, and/or usage data associated with each user (e.g., activity data associated with each user).

The pre-registered card information of a card may include a card type (e.g., credit card, membership card, identity card, etc.), a card issuer (e.g., a credit carrier, a company, the government, etc.), a credit carrier type (e.g., Visa, Mastercard, American Express, Discover, etc.), a card number, a card expiration date, and/or a card security code. The pre-registered account information may include user's name, user's mailing address, user's telephone number, user's email address, user's birthdate, user's gender, user's social security number, user account ID and associated password, or any other personal information about the user. In some embodiments, the pre-registered card information also includes magnetic fingerprint data and swipe characteristics of a card associated with each user.

The pre-registered card information, account information, and/or device information may be obtained and stored in the databases of the authentication service system during registration process. The authentication service system may have access to the databases or a subset of the databases for storing the pre-registered card information, account information, and/or the device information. In some embodiments, the pre-registered card information, account information, and/or device information may only be accessible by the authentication service system. For instance, any third-party entity may or may not be able to access the same databases or a subset of the same databases for storing the pre-registered card information, account information, and/or device information.

The third-party entity 670a, 670b may include, but are not limited to, a merchant's system, a broker's system, a credit card company, a social network platform, a government department, and/or other entities that may require card authentication reads. The third-party entity may be configured to offer various services to the user which may or may not include exchange of money and/or goods. The services may include any situation where a card reader may be used to read a card for authentication as discussed elsewhere herein. The services may be performed completely online (e.g., online shopping, online social networking, online registration and/or fee payments). The services may be performed completely in physical locations (e.g., shopping at a supermarket, backing services at a bank, registration at the city hall, etc.). The services may also include partially online activities in combination with partially physical activities.

The third-party entity may be implemented on one or more standalone data processing apparatuses or a distributed network of computers. In some embodiments, the entity may also employ various virtual devices and/or services of third party service providers (e.g., third-party cloud service providers) to provide the underlying computing resources and/or infrastructure resources. In some embodiments, upon user's approval and in pursuance to related privacy policies, the third-party entity may or may not store pre-registered card information, account information, usage data, and/or device information associated with the user. One or more third-party entities may comprise e-commerce systems, retail systems, financial institutions (e.g., banks, brokers, and credit card companies), merchant's systems, social networking platforms, and/or other entities which the user performs authentication reads with. In some instance, the third-party entity may be an online e-commerce, and a user may perform an authentication read of a credit card to complete a purchase of a product online. In some instance, the third-party entity may be a broker system, and a user may perform an authentication read of a card for verifying transfers of funds between the user's financial account and the broker system. In some instance, the third-party entity may be a social networking platform which hosts a plurality of user accounts. A user may use the authentication read of a card for verifying user's login to the social networking platform.

Communications in system 600 can be directed between the third-party entity and one or more user devices. In some instances, communications can also be directed between the third-party entity and the one or more card readers. Alternatively, communications between the third-party entity and the card readers can only be conducted through the corresponding user devices.

Users 605a, 605b may receive respective card readers 615a, 615b in person as discussed elsewhere herein. For example, the user may pick up the card reader at a location in person. Alternatively, the card reader may be delivered to the user in person. User identity verification may be performed in person by checking user's identity documents and/or user's biometric characteristics. Alternatively, user identity verification may be performed online by authentication service system. After the user identity has been verified, the card reader may be registered to be associated with the user. The card reader identifier may be stored to be associated with the user account. The card reader identifier and other user account data may be stored in one or more memory units associated with or accessible to the card reader, the user device, and/or the authentication service. The user may further register one or more cards using the card reader as described elsewhere herein. Each card may include a magnetic stripe which is encoded with card information, magnetic fingerprint data, and/or account information of the card holder. The magnetic stripe may be used to determine magnetic fingerprint data which is unique to the corresponding card. The cards and the associated magnetic stripes may include one or more characteristics of the various embodiments of the cards and the magnetic stripes described elsewhere herein. The pre-registered card data, magnetic fingerprint, and swipe characteristics may be stored to be associated with the user. Users 605a, 605b may use pre-registered cards in various user activities. The cards may aid in the transfer of funds and/or may aid in identifying or authenticating a user.

Steps for performing secure authentications may be implemented according to various embodiments. Requests for authentication reads may be initiated at user side. For example, a user may initiate a request for a secure authentication read to complete a transaction. In some embodiments, during a user activity, the user may send a user input (e.g., by pressing a button or touching a touch screen of a user device or a card reader) to indicate the user's intention to initiate a secure authentication. In some embodiments, requests for secure authentication reads may be initiated from a user device or a card reader. In some instances, a request for a secure authentication read may be initiated from an authentication server system. In some instances, a request for a secure authentication read may be initiated from a third-party entity.

During initial registration of a user account with an authentication server system, the user may register for relevant account settings to require secure authentication reads for user activities associated with this user account. During the following activities, the authentication server system may recognize a request for an authentication read associated with the user account. For example, in response to the request for a transaction, the authentication server system may send a request for a secure authentication to complete the transaction. During registration and/or the following account activities, the user may register to require authentication reads for all activities or some activities with certain conditions. The conditions for initiating requests for authentication reads may also be requested during registration of the card reader and/or one or more cards with the authentication service system.

During initial registration of a user account with a third-party entity, the user may register for relevant account settings to require secure authentication reads for activities associated with this user account. For example, during initial setup of a user account to activate or manage a card on a bank's website or within the bank's application, the user may select to perform secure authentications for one or more activities. During the following activities, once the third-party entity recognizes a user activity associated with the user account is requested, a secure authentication read is required to complete this activity using the card. During registration and/or the following account activities, the user may register to require authentication reads for all activities or some activities with certain conditions.

The secure authentications may be required or provided as an option by an authentication server system. In some embodiments, the secure authentications may be required by a third-party entity. For example, a bank system or a broker system may require secure authentications to be performed to complete all or certain transactions (e.g., flagged transactions, transactions above a predetermined limit amount, or randomly selected transactions). In some instances, a secure authentication may be optional, but the third-party entity may offer rewards (e.g., cashback or bonus reward points) to the user if the user chooses to perform a secure authentication to complete the transaction.

The secure authentications may be required for all or some activities associated with the user account. For example, a secure authentication may be required when a transaction involves an amount of money equal to or greater than a predetermined threshold amount. For example, the predetermined threshold amount may be $100, $200, $500, $1000, $5000, $8000, $10,000, $15,000, $20,000. The threshold amount may be determined by the user, an authentication server system, or a third-party entity. In some embodiments, secure authentications may be required when the activities are identified as high risk activities. For example, the high risk activities may involve suspicious/mismatched user identity associated with the user account, suspicious transaction locations, repetitive entering of wrong user information, and/or flagged user account for previously associated fraudulent activates. In some embodiments, high risk activities may involve high speed transactions, such as requiring for funds to be transferred within a short period of time. When high speed transactions are identified, further security checks, such as authentication reads, may be required from the user. In some instances, the use of the further authentication may allow for online activities to occur in situations where previously in-person activity was required. The further assurances of a user's identity may aid in giving entities comfort in permitting larger scale transactions.

As illustrated in FIG. 6, a user (e.g., users 605a, 605b) may perform an authentication read for a user activity. In one example, the user may perform a transaction of exchanging money, goods, and/or services with a third-party entity (e.g., third-party entities 670a, 670b). In another example, the user may purchase an item online from an e-commerce. In yet another example, the user may transfer money to a broker system. In yet another example, the user may login to a pre-registered user account on a social networking platform. The user may perform the activity on a website or in an application associated with the third-party entity.

The user may or may not log into a registered user account with the third-party entity (e.g., a public service, an online voting system, a social networking service, etc.) to perform the activity. When the user logs into a pre-registered user account, the third-party entity may identify the user's identity based on the login information. When the user does not log into a pre-registered user account, the third-party entity may identify the user's identity during the following authentication read, e.g., when the user swipes a card.

The third-party entity may send a request for an authentication read to an authentication service system. The third-party entity may request for authentication reads per requirement of the third-party entity. Alternatively, the third-party entity may request for authentication reads per user accounting settings registered with the third-party entity.

After receiving the request from the third-party entity, the authentication service system may send a request for an authentication request to the user. The request may be sent to a user device or a card reader associated with the user. In response to the request, the user device or the card reader may display a notification. The notification may require the user to swipe a card (e.g., an identity card, a credit card, a membership card, etc.) through the card reader to perform the secure authentication read. The notification may also require the card reader, which has been pre-registered to be associated with the user, to be coupled with the user device to perform the authentication read.

In some alternative embodiments, the request to perform an authentication read may be initiated by the user. For example, the user may indicate the intention to perform the secure authentication via a user input on the user device. For example, the user may click an icon on the display or press a button on the user device to request for the secure authentication. The user may connect the card reader with the user device and a request for the secure authentication may be automatically displayed on the user device.

In response to the request for authentication read, the user may swipe the card through the card reader. A sensing unit of the card reader may collect various information associated with the card during the swipe. For example, as the user swipes the card, the sensing unit may be configured to obtain the encoded data in the magnetic stripe and/or magnetic fingerprint data of the stripe. The sensing unit of the card reader may also obtain one or more swipe characteristics (e.g., speed of swipe, direction of swipe, angle of swipe (or swipe path), timing of swipe, and/or pressure of swipe as discussed herein). The collected data may be transmitted to the authentication service system for verification.

The user device may obtain the card reader identifier of the card reader when a communication is established between the card reader and the user device either wirelessly or via a wired connection. The card reader may also transmit the card reader identifier to the user device at any stage of the secure authentication read. The card information (e.g., magnetic fingerprint of the card), swipe characteristics, and/or the card reader identifier may be transmitted to the authentication service system for verification.

As discussed earlier, the authentication service system and/or the third-party entity may identify the user's identity by user's login information. The authentication service system may retrieve pre-registered data associated with the identified user. The data collected by the card reader and the card reader identifier may be compared with the corresponding pre-registered data. For example, the authentication service system may compare the collected card number and type with corresponding information of the one or more pre-registered cards of the user. The authentication service system may further compare the collected magnetic fingerprint data of the identified card pre-registered to the user. The authentication service system may also compare the collected swipe characteristics and/or the card reader identifier with the respective pre-registered swipe characteristics and/or the card reader identifier of the user. Alternatively or in combination, the data collected by the card and card reader identifier may be compared with historic authentication reads data, e.g., data collected from a predetermined number of most recent authentication reads.

When the user's identity cannot be identified from a user's login process, data collected during authentication reads may be used to identify the user's identity based on the corresponding data from pre-registered data. For example, during the authentication read, the card reader may collect data encoded in a magnetic stripe, such as card number, card holder name, and/or carrier. The encoded data may be used to identify a pre-registered card and the corresponding user. The authentication service system may further verify the authentication reads by comparing other collected data with the corresponding pre-registered data of the identified user. Alternatively or in combination, the collected data may also be compared with historic authentication reads data, e.g., data collected from a predetermined number of most recent authentication reads. Various embodiments for performing authentication reads based on historic authentication reads data are described in U.S. Provisional Application 62/239,744 (Attorney Docket No. 48233-702.102), filed on Oct. 9, 2015, the disclosure of which is incorporated herein by reference in its entity.

When one or more types of data received from the card reader do not match the corresponding pre-registered data or historic authentication reads data, the authentication service system may reject the activity. An alert may be displayed to the user. Additional verification may be required from the user to proceed with the activity. A flag notification may be sent to the third-party entity to flag and/or reject the activity.

In some embodiments, one or more steps of the authentication reads may be performed locally at a user device or a card reader. A verification result may be transmitted to the authentication service system. The authentication server system can simultaneously perform authentication reads for multiple activities. The authentication server system may simultaneously perform authentication reads for multiple separate third-party entities. The user activities, e.g., logins or transactions, may be approved, rejected, or flagged as a risk logins or transactions based on the comparison result.

Various embodiments may exist for evaluating the match between the collected data and pre-registration data. For example, the authentication reads may be considered passed when one or more items of the collected magnetic fingerprint, swipe characteristics, and card reader identifier match the respective pre-registration data. The collected swipe characteristics may need to be completely identical to the pre-registered swipe characteristics to be considered a match (e.g. 100% match). Alternatively, the collected swipe characteristics may need to fit within a pre-registered data range of swipe characteristics. In some instances, a perfect 100% match may be suspicious. For instance, each time a user swipes a card, there is likely to be some minor variation. Physically it is extremely unlikely that an individual swipe a card with exactly the same swipe characteristics. Having the exact same characteristics may be an indicator of a type of replay attack.

Alternatively, there may be some leeway in how closely the swipe characteristics match. If the level of match exceeds a predetermined threshold, then the swipe characteristics may be considered a match. For example, if the swipe characteristics match by more than 70%, 75%, 80%, 85%, 90%, 95%, 97%, 99%, 99.9%, 99.99%, then the swipe characteristics may be considered a match. In some instances a ‘sweet spot’ of matching may be provided, where the swipe characteristics may exceed a particular threshold, but may be beneath an identical match that may be considered suspicious. For instance, to constitute a proper match, the swipe characteristics may be less than or equal to about 100%, 99.999%, 99.99%, 99.9%, 99%, 98%, 97%, 95% or 90%. To constitute a match, the swipe characteristics may have a value greater than any of the lower values described herein, and simultaneously a value less than any of the higher values described herein. For instance, to qualify as a match, the swipe characteristics may have an overall value (e.g., weighted value of multiple swipe characteristics, or a value of a single swipe characteristic), of greater than 80% while being less than 99.99%.

In some embodiments, the collected magnetic fingerprint may need to be completely identical to the previously stored magnetic fingerprint(s) to be considered a match (e.g. 100% match). Alternatively, there may be some leeway in how closely the magnetic fingerprints match. If the level of match exceeds a predetermined threshold, then the magnetic fingerprints may be considered a match. For example, if the fingerprints match by more than 70%, 75%, 80%, 85%, 90%, 95%, 97%, 99%, 99.9%, 99.99%, then the fingerprints may be considered a match.

In some embodiments, a magnetic fingerprint of a card may change over time. For instance, the magnetic stripe may become slightly demagnetized. Scratches or other wear may affect the magnetic stripe. Such natural adjustments to the magnetic stripe may affect the magnetic fingerprint. In some instances, the leeway in how closely the magnetic fingerprints match may permit some natural change in the magnetic fingerprint over time as the magnetic stripe undergoes regular use. However, if a drastic change were to occur, it may fall outside the leeway range, and may be flagged as a potentially different card.

The comparison of the magnetic fingerprint may be relative to an original registration magnetic fingerprint. The threshold may allow from some variability from the original swipe, but may not allow the card to deviate too greatly from the original swipe. In another example, the comparison of the magnetic fingerprint may be relative to a single most recent or multiple most recent fingerprints. The threshold may allow for some change relative to the previous swipe(s), and may be more accommodating of evolution over time. For instance, the magnetic fingerprint may change gradually from swipe to swipe over time, and over a great length of time, may deviate more significantly from an original registration fingerprint as opposed to a more recent fingerprint. In some instances, multiple thresholds may be provided. For instance, a lower threshold may be provided when comparing the magnetic fingerprint with an original registration fingerprint (e.g., requiring at least 80% match) while a higher threshold may be provided when comparing the magnetic fingerprint with a recently fingerprint (e.g., requiring at least a 99% match with the most recent fingerprint). The magnetic fingerprint may be compared with an average of one or more of the earlier fingerprints. In some instances, the magnetic fingerprint may be compared with an average of all of the previous fingerprints.

As previously described, an indication of fraud may provide an indication of a level of fraud risk. The level of fraud risk may optionally depend on the level of match of the magnetic fingerprints. For instance, if the magnetic fingerprints are a 100% match, the level of fraud risk may be none, or very low. If the magnetic fingerprints are a 70% match, the level of fraud risk may be moderate, and if the magnetic fingerprints are a 40% match, the level of fraud risk may be high. The level of fraud risk may be inversely proportional to a level of match of the fingerprints. A higher match may correlate to a lower risk of fraud. A lower match may correlate to a greater risk of fraud.

In some embodiments, the comparison of the collected data and the pre-registered data may be assigned a matching score, and when the matching score is no lower than a predetermined threshold, such as 70%, 80%, 90%, or 95% of similarity, the authentication read is approved. Otherwise, when the matching score is below the predetermined threshold, the authentication read is rejected. Optionally, an indication of a likelihood of fraud may be provided based on the matching score. User activities may be approved or rejected depending on the comparison results. An alert including level of match and/or a level of risk may be provided to the third-party entities and/or the user.

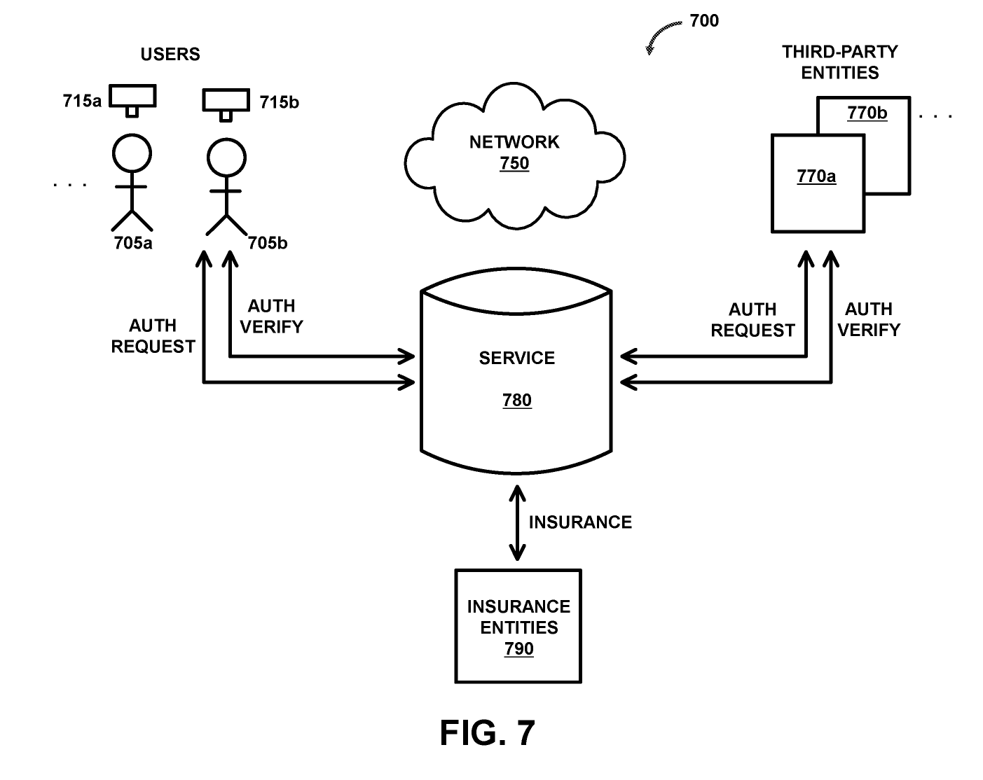

FIG. 7 shows a schematic authentication system 700 illustrating various authentication reads, in accordance with an embodiment of the invention. The authentication system 700 may include one or more card readers 715a, 715b associated with respective users 705a, 705b, an authentication service 780 (e.g., a server system configured to provide card authentication reads service), one or more third-party entities 770a, 770b (e.g., a merchant's system, a broker's system, a social networking platform, or other entity requiring card authentication reads), and communication network(s) 750 for providing communications between these components. In some instances, the authentication system may also comprise one or more user devices (not shown) in communication with respective card readers. The respective users may perform user activities and authentication reads using the user device. The user may swipe a card (not shown) through the corresponding card reader to register the card reader and the card. The user may also swipe the registered card through the card reader to perform authentication reads in various activities. Various embodiments of the authentication system 700 may be similar to the authentication system 600 as discussed in FIG. 6. In addition to the features disclosed in FIG. 6, the authentication system 700 may further comprise one or more insurance entities 790 for insuring the authentication reads.

The one or more insurance entities 790 may provide insurance for authentication reads associated with various user activities. One or more insurance entities may provide insurance service(s) to the authentication service system 780. For example, for an authentication read, a premium may be charged by an insurance entity in exchange for covering a risk of loss associated with the authentication read. In one example, if an authentication read is passed and services have been offered by a third-party entity. However a problem occurs for this transaction, such as a failure of card charge. The third-party entity may pursue damage recovery from the authentication service system, e.g., request for certain amount of payment from the authentication service system to the third-party entity. Under this circumstance, after being insured with one or more insurance entities, the authentication service system may receive certain amount of payment or certain percentage of the lost from one or more insurance entities to cover its own lost. A deductible may be required by one or more insurance entities for insuring authentication reads for certain types of user activities. In another example, the authentication service system may require insurance service(s) from one or more insurance entities for authentication reads marked with certain levels of risk as discussed elsewhere herein. One or more insurance entity may also provide other insurance services to the one or more third-party entities. An insurance entity may be a third-party entity.

The one or more insurance entities may be implemented on one or more standalone data processing apparatuses or a distributed network of computers. The one or more insurance entities may also employ various virtual devices and/or services of third party service providers (e.g., third-party cloud service providers) to provide the underlying computing resources and/or infrastructure resources. Communications in authentication system 700 can be directed between the one or more insurance entities 790 and authentication service system 780. In some instances, communications can also be directed between the one or more third-party entities 770 and the one or more insurance entities 790 directly or indirectly through the authentication service system 780.

In some instances, insurance services may be requested by the third-party entity on authentication reads for user activities. Alternatively, the insurance services may be requested by the third-party entity for authentication reads for transactions involving an amount of money more than a predetermined threshold value, such as $1000, $2000, $300, $4000, $5000, or $10000. The third-party entity may also request the insurance services for authentication reads for high risk activities or authentication reads marked with high risk flags. The third-party entity may select insurance services from a plurality of insurance entities. A bidding process or an auto-bidding system may be used for the third-party entity to determine which one or more insurance entities to select.

The premium charged by the insurance entity may be a fixed fee for each authentication read. Alternatively, the premium charged by the insurance entity may be a predetermined percentage of the transaction amount. Alternatively, the premium may be a monthly, semi-annual, or annual payment to insure authentication reads for transactions or other activities, within the corresponding period. The insurance entity may charge the authentication service system for the insurance service. The third-party entity may pay the authentication service system to cover the cost for authentication reads and/or the insurance services.

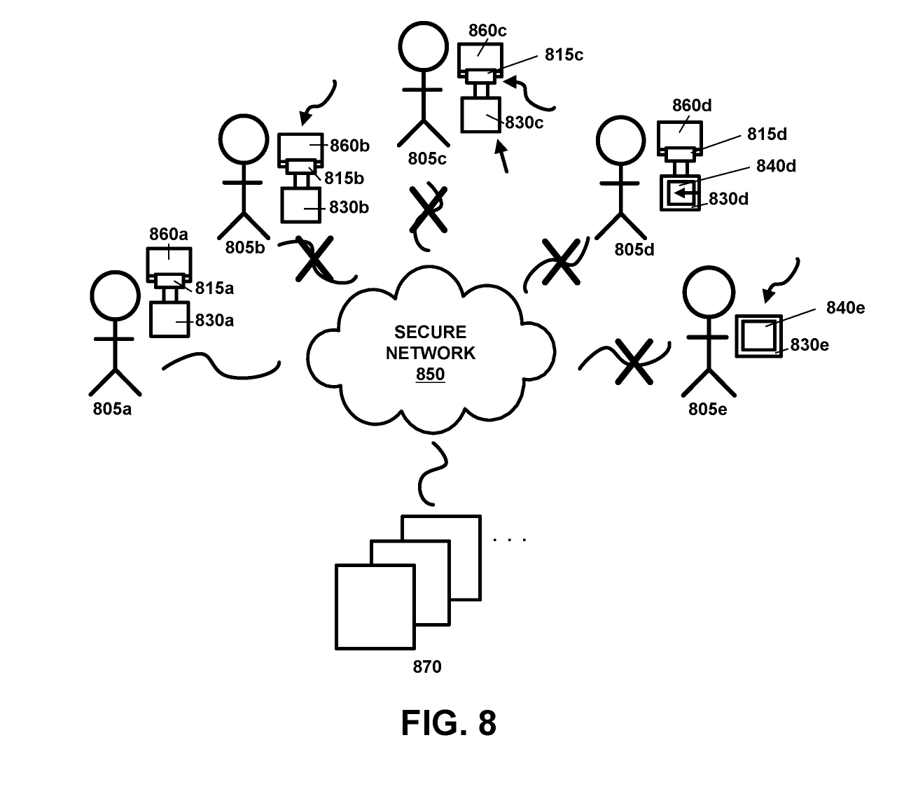

FIG. 8 shows examples of various scenarios where authentication reads for various user activities may be approved or rejected, in accordance with some embodiments of the invention. The user activities may or may not include the exchange of money, goods, information, and/or services. The user activities may include donations. The user activities may include any situation where a card reader may read a card. This may occur regardless of whether money is transferred or not. For instance, a user may swipe a user's library card to check out a book. A user activity may include verification of a user's card and/or a user's identity. The authentication read may be performed on a user device using a separate mobile application or within the same application used for the user activity.

A user (e.g., users 805a, 805b, 805c, 805d, 805e) may initiate one or more user activities (e.g., transactions) with third-party entities 870 through communication network(s) 850. For example, the user may purchase a product from an online e-commerce, transfer money to a broker system, or login to a user account pre-registered on a website. The user may use a user device (e.g., user device 830a, 830b, 830c, 830d, 830e) to perform the user activities. The user may be requested to perform an authentication read during the user activity. For example, the user may be requested to swipe a pre-registered card (e.g., cards 860a, 860b, 860c, 860d, 860e) through a card reader (e.g., card readers 815a, 815b, 815c, 815d, 815e). The user device may be in communication with the third-party entities through a secure network 850. The card reader may be in communication with the third-party entities directly or through a user device connected with the card reader.

As described elsewhere herein, the user may receive a card reader prior to performing authentication reads. Upon receiving the card reader, the user may pre-register the card reader with an authentication service system. The user may also pre-register one or more cards using the registered card reader. After registration, the pre-registered carder reader identifier, card information, card holder information, magnetic fingerprint data, swipe characteristics, and/or user device identifier may be stored to be associated with a user account. The above listed information may be stored in one or more memory units associated with or accessible to the authentication service system. The information related to a user may also be stored in memory units associated with or accessible to the user device and/or the card reader registered to the user. The pre-registered data may be used for verifying authentication reads during various user activities. Historic authentication reads data may be stored and used in combination or independently from the pre-registration data for verifying authentication reads.

The pre-registration data and/or historic authentication reads data may all be stored together in a single memory unit or may be distributed over multiple memory units. Data distributed over multiple memory units may or may not be simultaneously accessible or linked. The pre-registration data and/or historic data may include data collected for a single card, or for multiple cards. Data from multiple cards may all be stored together or may be stored separately from one another. The pre-registration data and/or historic data may include data for a single user, or from multiple users. Data from multiple users may all be stored together or may be stored separately from one another. The pre-registration data and/or historic data may include data collected from a single card reader or from multiple card readers. Data from multiple card readers may all be stored together or may be stored separately from one another. In some instances, a single card reader may be pre-registered to be associated with a single user. Alternatively, multiple users may be pre-registered to share a single card reader, or a user may be registered to be associated with multiple card readers.

In one instance, the user 805a may perform a user activity using a user device 830a. For example, the user may log into a pre-registered user account with a third-party entity, such as an e-commerce site to purchase a product. A request for performing an authentication read may be displayed on the user device. The user may connect a card reader 815a, which has been pre-registered to be associated with the user, to the user device. The user device may identify a card reader identifier of the card reader. The user may then swipe a pre-registered card 860a through the card reader. A sensing unit of the card reader may collect data such as card information, card holder information, magnetic fingerprint data, and/or swipe characteristics during the swipe. The collected data, the card reader identifier, the user device identifier may be transmitted to the authentication service system. The authentication service system may then compare the collected data and the card reader identifier with corresponding pre-registered data of the user account. For example, the collected card information may be compared with the card information of one or more pre-registered card of the user. The collected magnetic fingerprint data may be compared with the pre-registered magnetic fingerprint data of the identified pre-registered card. The collected card reader identifier may also be compared with the pre-registered card reader identifier associated with the user account. The user device identifier may further be compared with the pre-registered device identifier associated with the user account. When all data from the authentication read, the card reader identifier, and the user device identifier match the respective pre-registered data of the user account, the authentication service system may send a message indicative of the positive authentication read result to the third-party entity. The authentication read for the user activity may be approved.

In some instances, when not all data can be obtained from the pre-registered user data, historic authentication reads data may be used to supplement the verification of authentication read. For example, the card reader identifier and the user device identifier may match the respective pre-registered data of the user account. However, the card the user is using cannot be identified as a pre-registered card. In this case, based on the collected card information, the card may be able to be identified as a card used by the same user in one or more previous authentication reads for user activities. The collected card information, magnetic fingerprint, and swipe characteristics may be compared with the data stored from related previous authentication reads. The authentication read may be approved when all collected data match the corresponding data stored from the historic authentication reads. Alternatively, the authentication read may be approved when certain amount of collected data match the corresponding data from historic authentication reads.

In another instance, the user 805b may perform a user activity using a user device 830b. For example, the user may transfer a large amount of money to a broker system. The broker system may request the user to perform an authentication read to complete the transfer. After the user swipes a pre-registered card 860b through a card reader 815b, the collected authentication read data may be transmitted to the authentication service system for verification. After comparing the magnetic fingerprint data and swipe characteristics collected during the swipe with the corresponding pre-registered data of the user, the authentication service system may determine the card is a clone card because the magnetic fingerprint data does not match the pre-registered magnetic fingerprint of this card. As previously discussed, the magnetic fingerprint data is unique to each card. Alternatively when the card is determined to be an authentic card based on the magnetic fingerprint comparison, the swipe characteristics of the current card possessor may be compared with the pre-registered swipe characteristics of the user. When the collected swipe characteristics do not match the pre-registered swipe characteristics, e.g., a matching extent/percentage between the collected data and the pre-registered data is below a predetermined lower matching threshold, the card may be determined to be a stolen card and the authentication read is rejected. Alternatively, when the collected swipe characteristics are exactly the same (e.g., or a matching extent/percentage is above a predetermined upper matching threshold) as the pre-registered swipe characteristics, the current authentication read may be rejected and flagged as a replay attack. An alert may be sent to the broker system and the money transfer may be rejected. The user may receive a notification indicative of the rejection of the activity.

In yet another instance, the user 805c may perform a user activity using a user device 830c. The user may be requested to perform a card authentication read for the user activity. The user may connect the card reader 815c to the user device, and then swipe the card 860c through the card reader. The card reader identifier and the user device identifier may be transmitted to the authentication service system for verification. In some instances, the transaction may raise a red flag because the authentication service system determines the card reader identifier does not match a pre-registered card reader identifier associated with the user. Alternatively, the authentication service system may determine the user device identifier does not match the pre-registered user device identifier associated with the user. The authentication read may be rejected. A request for further user verification may be sent to the user device.

In yet another instance, the user 805d may perform a user activity using a user device 830d. The user may be requested to input personal information in a mobile application 840d using the user device during the user activity. For example, the user may swipe a card 860d through the card reader 815d, and the user may be prompted to enter a PIN number associated with the card. The entered PIN number along with card information collected during the swipe may be transmitted to the authentication service system for verification. In some instances, the authentication service system may determine the card is a stolen card, because the PIN number does not match the registered PIN number of the same card. The authentication read may be rejected and any other activities with this card may be flagged. The current user activity may also be flagged. The registered user associated with the card may be notified for further verification.

In yet another instance, the user 805e may perform a user activity using a user device 830e. For example, the user may use a mobile application 840e which runs on the user device to purchase a product online. After the user select the desired product and proceed to checkout, a notification may be displayed on the user device which requests for an authentication read for the online purchase. For example, the notification may request the user to connect a registered card reader with the user device to perform the authentication read. The authentication read may not be performed if the user does not have the registered card reader or does not have a card reader at all. In some instances, the user may just receive a card reader and has not performed a proper registration. In some other instances, when the user receives the card reader in person as described elsewhere herein, the required user identity documents were not properly presented or the biometric characteristics did not match, thus the card reader may not be properly registered. When the user fails to use a pre-registered card reader to perform the requested authentication read, even if the user wants to input card information and user information within the mobile application or swipe a card with a card reader different from the registered card reader to proceed, the authentication read may not be able to go through. The third-party entity may reject the authentication read. The user may receive a notification on the mobile application to obtain a card reader and properly registered the card reader to be associated with the user account.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method of registering a user for performing a card authentication read, said method comprising:
verifying an identity of the user in person, comprising reviewing at least one official personal document of the user while face-to-face with the user;
providing the user with a card reader having a card reader identifier when the identity of the user is verified in person;
receiving pre-registration data for one or more cards of the user through the card reader; and
storing the pre-registration data for the one or more cards of the user to be associated with the card reader identifier in memory.

2. The method of claim 1, wherein the pre-registration data for the one or more cards comprises (1) a magnetic fingerprint of the one or more cards, or (2) a swipe characteristic of the one or more cards when read by the card reader.

3. The method of claim 2, wherein the magnetic fingerprint is associated with a distribution of magnetic particles of a magnetic stripe on the card.

4. The method of claim 2, wherein the swipe characteristic comprises a speed, direction, angle, timing, or pressure of a swipe as the card is swiped through the card reader.

5. The method of claim 1, wherein verifying the identity of the user further comprises verifying biometric data of the user.

6. The method of claim 1, wherein the at least one official personal document of the user is a national passport of the user.

7. The method of claim 1, wherein the pre-registration data for the one or more cards are collected with aid of one or more sensors on the card reader.

8. The method of claim 1, wherein the card reader is configured to be operably coupled to a user device via a rigid connection or a flexible connection.

9. The method of claim 8, wherein the card reader identifier is generated when the card reader is in communication with the user device.

10. The method of claim 9, wherein a software token is generated for the card reader identifier and sent to the user.

11. The method of claim 1, wherein the card reader identifier is contained in a hardware token shipped to the user.

12. A system of registering a user for performing a card authentication read, said system comprising:
(i) a communication unit for communicating with a card reader configured to operably couple to a user device, (ii) a memory for storing pre-registration data for one or more cards of the user to be associated with a card reader identifier, and a set of software instructions, and (iii) one or more processors configured to execute the set of software instructions to:
receive a detection of a connection between the card reader and the user device;
generate a card reader identifier uniquely associated with the card reader in response to the detection;
provide the card reader identifier to the user in the form of hardware token or software token;
receive the card reader identifier from the card reader or the user device; and
store the pre-registration data for the one or more cards of the user to be associated with the card reader identifier and verified user identity information in memory, wherein the pre-registration data for the one or more cards of the user is received through the card reader.

13. The system of claim 12, wherein the pre-registration data for the one or more cards comprises (1) a magnetic fingerprint of the one or more cards, or (2) a swipe characteristic of the one or more cards when read by the card reader.

14. The system of claim 12, wherein the card reader is provided to the user when an identity of the user is verified in person by reviewing at least one official personal document of the user while face-to-face with the user.

15. A tangible computer readable medium storing instructions that, when executed by one or more servers, causes the one or more servers to perform a computer-implemented method for registering a user for performing a card authentication read, said method comprising:
receiving a detection of a connection between a card reader and a user device;
generating a card reader identifier uniquely associated with the card reader in response to the detection;
transmitting the card reader identifier to the user in the form of hardware token or software token;
receiving the card reader identifier from the card reader or the user device; and
storing pre-registration data for one or more cards of the user to be associated with the card reader identifier and verified user identity information in memory, wherein the pre-registration data for the one or more cards of the user is received through the card reader.
